(19) United States
(12) Patent Application Publication
(10) Pub. No.: US 2026/0175504 A1
(43) Pub. Date: Jun. 25, 2026

(54) SYSTEM AND METHOD FOR BLOW MOLDING PLATE COMPONENTS FOR ARTICLES OF FOOTWEAR

(71) Applicant: NIKE, Inc., Beaverton, OR (US)

(72) Inventors: Jeremy D. Walker, Portland, OR (US); James M.F. Webster, Tigard, OR (US)

(73) Assignee: NIKE, Inc., Beaverton, OR (US)

(21) Appl. No.: 19/426,552

(22) Filed: Dec. 19, 2025

Related U.S. Application Data
(60) Provisional application No. 63/736,723, filed on Dec. 20, 2024.
(60) Provisional application No. 63/897,273, filed on Oct. 10, 2025.

(51) Int. Cl. B29C 49/04; B29C 49/22; B29C 49/48; B29C 49/78; B29L 31/50

(52) U.S. Cl. CPC B29C 49/04104; B29C 49/22; B29C 49/4802; B29C 49/78; B29C 2049/4807; B29C 2949/3044; B29L 2031/504

(57) ABSTRACT

A blow molding system includes a first extruder extruding a first material, an end die receiving the first material from the first extruder and including an inner portion, an outer portion, and a passage disposed between the inner portion and the outer portion through which the first material flows before exiting the end die as a parison, the inner portion movable relative to the outer portion to adjust a width of the passage. The blow molding system further includes a mold assembly defining a mold chamber having an opening at one end that receives the parison, the mold assembly including a plurality of mold cavities each facing the mold chamber and defining a profile of at least one sole component of an article of footwear.

### CROSS REFERENCE TO RELATED APPLICATIONS

This application claims priority under 35 U.S.C. § 119(e) to U.S. Provisional Application No. 63/897,273, filed on Oct. 10, 2025 and U.S. Provisional Application No. 63/736,723, filed on Dec. 20, 2024. The disclosures of these prior applications are considered part of the disclosure of this application and are hereby incorporated by reference in their entirety.

### FIELD

The present disclosure relates generally to a system for molding a sole plate for an article of footwear, and more particularly, to a system for simultaneously blow molding a plurality of sole plates for articles of footwear.

### BACKGROUND

This section provides background information related to the present disclosure and is not necessarily prior art.

Articles of footwear conventionally include an upper and a sole structure. The upper may include any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. One layer of the sole structure includes an outsole that provides abrasion-resistance and traction with the ground surface. The outsole may include a sole plate formed of a rigid or semi-rigid material that provides rigidity and energy distribution across the sole structure. The sole plate may be provided with one or more types of traction elements for maximizing engagement with a ground surface. In some cases, the traction elements may be fixed to the outsole plate or integrally molded with the sole plate. Sole plates are typically manufactured using injection molding processes.

### DRAWINGS

The drawings described herein are for illustrative purposes only of selected configurations and not all possible implementations, and are not intended to limit the scope of the present disclosure.

FIG. 1 is a schematic view showing a cross section of an example configuration of a blow molding system in accordance with the principles of the present disclosure;

FIG. 1A is an enlarged partial schematic view of adjustment elements according to the present disclosure, the adjustment elements in a first orientation;

FIG. 2A is top-down view of a circular adjustment element in accordance with the principles of the present disclosure;

FIG. 2B is top-down view of a oblong adjustment element in accordance with the principles of the present disclosure;

FIG. 3A is a schematic view showing the cross section of the blow molding system of FIG. 1, where a molding material is extruded into a mold as a parison with the adjustment elements in a second orientation;

FIG. 3B is a schematic view showing the cross section of the blow molding system of FIG. 1, where a molding material is extruded into a mold as a parison with the adjustment elements in the first orientation;

FIG. 4 is a schematic view showing the cross section of the blow molding system of FIG. 1, where a mold assembly is moved to a closed configuration;

FIG. 5 is a schematic view showing the cross section of the blow molding system of FIG. 1, wherein the parison is expanded into mold cavities of the mold;

FIG. 6 is a schematic view showing the cross section of the blow molding system of FIG. 1, wherein the mold is opened for removal of a molded article;

FIG. 7 is a perspective view of the molded article of FIG. 5, showing a step of separating molded article sections;

FIG. 8 is a perspective view of the separated molded article sections of FIG. 6;

FIG. 9 is a perspective view of one of the separated molded article sections of FIG. 7, showing a sole plate being removed from the molded article section;

FIG. 10 is a schematic view showing a cross section of an example configuration of a blow molding system in accordance with the principles of the present disclosure;

FIG. 10A is an enlarged partial schematic view of adjustment elements according to the present disclosure;

FIG. 11A is a schematic view showing an example of an adjustment element;

FIG. 11B is a schematic view showing another example of an adjustment element;

FIG. 12 is a schematic view showing the cross section of the blow molding system of FIG. 10, where a molding material is extruded into the mold;

FIG. 13 is a schematic view showing the cross section of the blow molding system of FIG. 10, where a mold assembly is moved to a closed configuration;

FIG. 14 is a schematic view showing the cross section of the blow molding system of FIG. 10, wherein the parison is expanded into mold cavities of the mold;

FIG. 15 is a schematic view showing the cross section of the blow molding system of FIG. 10, wherein the mold is opened for removal of a molded article;

FIG. 16 is a perspective view of the molded article of FIG. 15, showing a step of separating molded article sections;

FIG. 17 is a perspective view of the separated molded article sections of FIG. 16;

FIG. 18 is a perspective view of one of the separated molded article sections of FIG. 17, showing a sole plate being removed from the molded article section;

FIG. 19 is a perspective view of an article of footwear equipped with a sole component according to the present disclosure;

FIG. 20A is a schematic view showing the cross section of the blow molding system of FIG. 1, where first portion of a parison including a first mold material is extruded into the mold;

FIG. 20B is a schematic view showing the cross section of the blow molding system of FIG. 1, where second portion of the parison including a combination of the first mold material and a second mold material is extruded into the mold;

FIG. 20C is a schematic view showing the cross section of the blow molding system of FIG. 1, where a third portion of the parison including the second mold material is extruded into the mold;

FIG. 20D is an enlarged view of the second portion of the parison taken at Area 20D of FIG. 20C;

FIG. 21 is a schematic view showing the cross section of the blow molding system of FIG. 20C, where the mold assembly is moved to a closed configuration;

FIG. 22 is a schematic view showing the cross section of the blow molding system of FIG. 20A, wherein the parison is expanded into mold cavities of the mold;

FIG. 23 is a schematic view showing the cross section of the blow molding system of FIG. 22, wherein the mold is opened for removal of a molded article;

FIG. 24 is a perspective view of the molded article of FIG. 23, showing a step of separating molded article sections;

FIG. 25 is a perspective view of the separated molded article sections of FIG. 24; and

FIG. 26 is a perspective view of one of the separated molded article sections of FIG. 25, showing a sole plate being removed from the molded article section.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

An aspect of the disclosure provides a blow molding system including a first extruder extruding a first material, an end die receiving the first material from the first extruder and including an inner portion, an outer portion, and a passage disposed between the inner portion and the outer portion through which the first material flows before exiting the end die as a parison, the inner portion movable relative to the outer portion to adjust a width of the passage. The blow molding system further includes a mold assembly defining a mold chamber having an opening at one end that receives the parison, the mold assembly including a plurality of mold cavities each facing the mold chamber and defining a profile of at least one sole component of an article of footwear.

Aspects of the disclosure may include one or more of the following optional features. In some aspects, the system further includes a second extruder extruding a second material, the second material cooperating with the first material to form the parison. In some examples, the first extruder extrudes a first layer of the parison and the second extruder extrudes a second layer of the parison, the first layer being concentric with the second layer. In some implementations, the system further includes a third extruder extruding a third material defining a third layer of the parison. In some configurations, the first extruder and the second extruder are disposed upstream of the third extruder. In some aspects, the inner portion is translatable relative to and within the outer portion between an extended state and a retracted state, the parison having a first wall thickness when the inner portion is in the extended state that is greater than a second wall thickness when the inner portion is in the retracted state. In some examples, the inner portion includes an adjustment element disposed at a distal end of the inner portion and opposing the mold assembly, the adjustment element cooperating with an inner surface of the outer portion to define a shape of the parison, as the parison exits the end die. In some implementations, the adjustment element is circular. In some configurations, the adjustment element is oblong. In some aspects, the system further comprises a controller operably coupled with the inner portion to selectively adjust a position of the inner portion relative to the outer portion.

An aspect of the disclosure provides a blow molding system including a first extruder extruding a first material, an end die receiving the first material from the first extruder and including an inner portion, an outer portion, and a passage disposed between the inner portion and the outer portion through which the first material flows before exiting the end die as a parison. The blow molding system further includes a controller operably coupled with the inner portion to selectively move the inner portion relative to the outer portion between an extended state and a retracted state to adjust a width of the passage. The blow molding system further includes a mold assembly defining a mold chamber having an opening at one end that receives the parison, the mold assembly including a plurality of mold cavities each facing the mold chamber and defining a profile of at least one sole component of an article of footwear.

Aspects of the disclosure may include one or more of the following optional features. In some aspects, the system further includes a second extruder extruding a second material, the second material cooperating with the first material to form the parison. In some examples, the first extruder extrudes a first layer of the parison and the second extruder extrudes a second layer of the parison, the first layer being concentric with the second layer. In some implementations, the system further includes a third extruder extruding a third material defining a third layer of the parison. In some configurations, the first extruder and the second extruder are disposed upstream of the third extruder. In some aspects, the inner portion is translatable relative to and within the outer portion between the extended state and the retracted state, the parison having a first wall thickness when the inner portion is in the extended state that is greater than a second wall thickness when the inner portion is in the retracted state. In some examples, the inner portion includes an adjustment element disposed at a distal end of the inner portion and opposing the mold assembly, the adjustment element cooperating with an inner surface of the outer portion to define a shape of the parison, as the parison exits the end die. In some implementations, the adjustment element is circular. In some configurations, the adjustment element is oblong. In some aspects, the inner portion is movable relative to the outer portion to a plurality of positions between the extended state and the retracted state.

The details of one or more implementations of the disclosure are set forth in the accompanying drawings and the description below. Other aspects, features, and advantages will be apparent from the description, the drawings, and the claims.

The present disclosure provides a system and method for blow molding polymer components for articles of footwear, and particularly, multi-layer sole plates for articles of footwear. Conventionally, sole plates and other polymeric components of footwear are manufactured using injection molding processes, or in some instances, additive manufacturing (e.g., three-dimensional printing). While suitable, injection molding processes can be relatively costly due to the complexity of molds and molding materials. Additionally, injection molding processes may limit the types of materials that can be used, as some chemistries of materials are not compatible with each other when combined in an injection molding process. Further, these processes can be time and labor intensive. Blow molding is a low-cost and efficient manufacturing method that enables lightweight products to be manufactured that can be mono-layer or multi-layer, thereby enabling unique material combinations to be achieved in a single process. Additionally, molds associated with blow molding systems are typically less expensive relative to molds associated with injection molding processes. As discussed herein, the molds used with blow molding processes may include multiple mold plates for forming a plurality of mold plates simultaneously. Use of extruded materials in a blow molding process also enables the option of incorporating recycled content or foamed layers within the center layers of a sole plate, thereby improving sustainability while maintaining desired aesthetics and performance qualities.

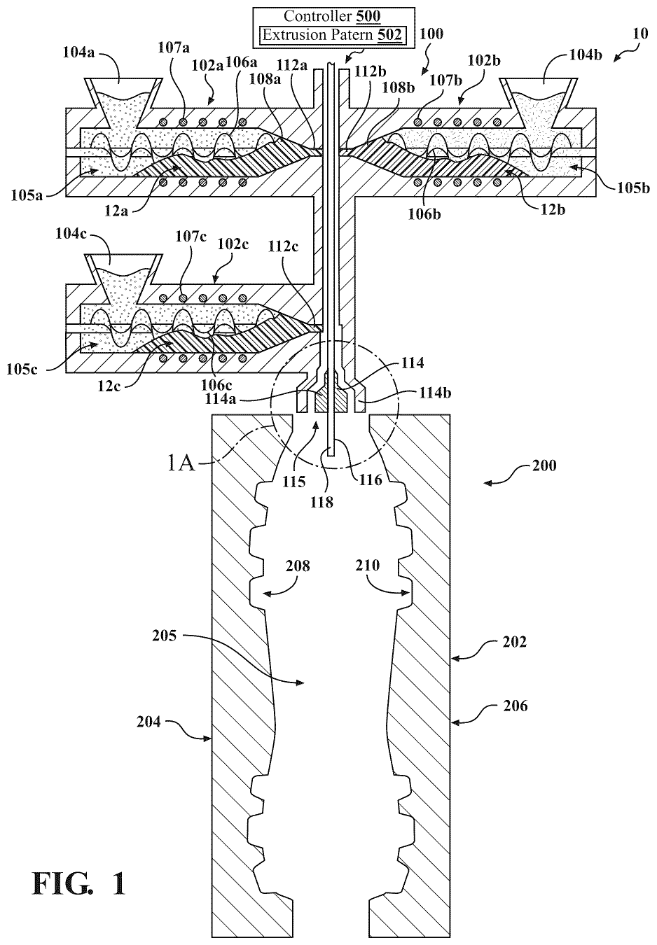

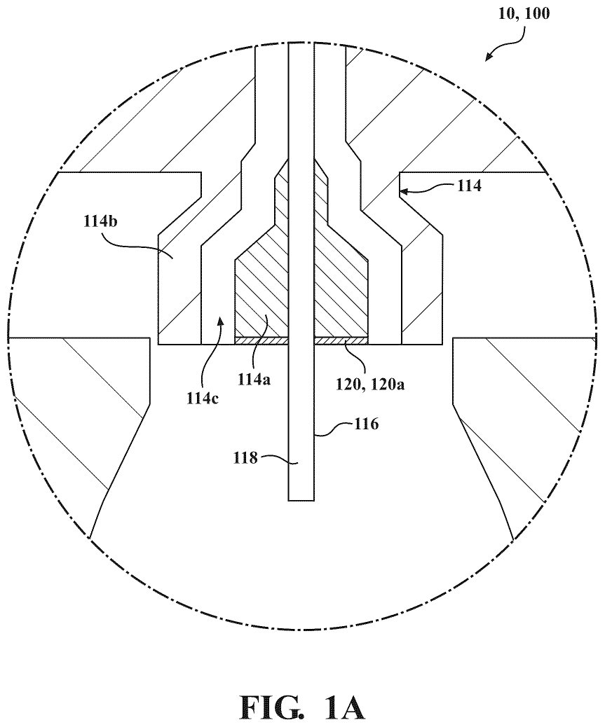

Referring to FIGS. 1-5, a blow molding system 10 is provided according to an example of the present disclosure. The blow molding system 10 includes an extrusion system 100 and a mold system 200 configured to produce a blow-molded article 300 including one or more footwear components. For example, in some configurations, the footwear components may include a plurality of sole plates 306, 308 for use in manufacturing of an article of footwear 400. Thus, the plurality of the sole plates 306, 308 can be simultaneously formed by the blow molding system 10. In alternative configurations, the footwear component may include other components or portions of an article of footwear, such as heel counters, integral sole plates, integral heel counter units, or any other practicable footwear component that may be produced using the blow molding system. The extrusion system 100 may also include a controller 500 configured with a predetermined extrusion pattern 502. The controller 500 may be configured to execute one or more extruders 102a, 102b of the extrusion system 100 to, ultimately, produce the blow-molded article 300, described herein.

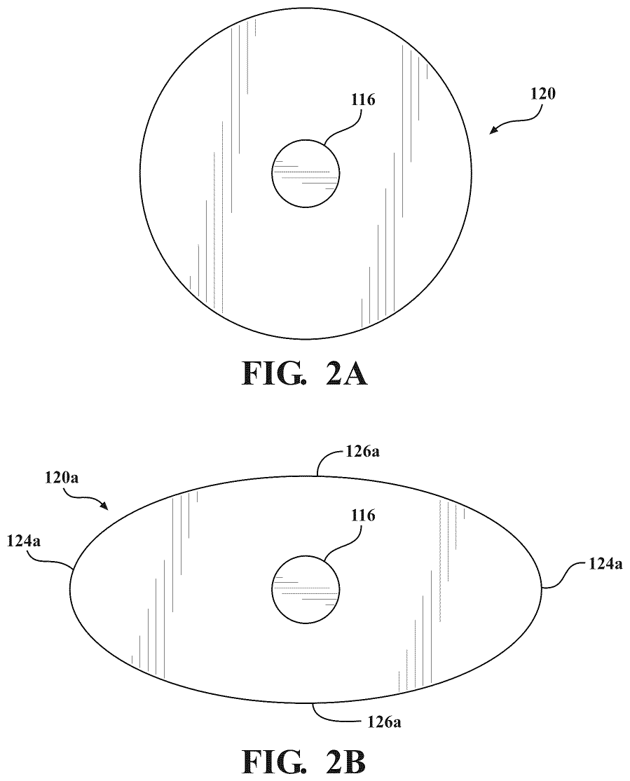

Referring to FIGS. 1-2B, the extrusion system 100 includes one or more extruders 102a-d, including a first extruder 102a configured to extrude a first mold material 12a, a second extruder 102b configured to extrude a second mold material 12b, and a third extruder 102c configured to extrude a third mold material 12c. In this configuration, the second material 12b may be encapsulated or interposed between the first mold material 12a and the third mold material 12c. While the illustrated example is provided with first, second, third, and fourth extruders 102a-102c, for the sake of clarity, it should be appreciated that the extrusion system 100 may include less extruders or additional extruders as desired.

The first extruder 102a includes a first hopper 104a for receiving the first mold material 12a in a raw form, such as, but not limited to, in a pellet form, powder form, shaving form, molten form or any other practicable raw form of the first material 12a. The first extruder 102a further includes an extruder barrel 105a including a first extruder screw 106a and a heating element 107a for heating the first mold material 12a to a molten state. The extruder barrel 105a includes a first nozzle 108a disposed at an end of the first extruder screw 106a for receiving the molten first mold material 12a.

The second extruder 102b includes a second hopper 104b for receiving the second mold material 12b in a raw form, such as, but not limited to, in a pellet form, powder form, shaving form, molten form, or any other practicable raw form of the second material 12b. The second extruder 102b further includes an extruder barrel 105b including a second extruder screw 106b and a heating element 107b for heating the second mold material 12b to a molten state. The extruder barrel 105b includes a second nozzle 108b disposed at an end of the second extruder screw 106b for receiving the molten second mold material 12b.

The third extruder 102c includes a third hopper 104c for receiving the third mold material 12c in a raw form, such as, but not limited to, in a pellet form, powder form, shaving form, molten form, or any other practicable raw form of the third material 12c. The third extruder 102c further includes an extruder barrel 105c including a third extruder screw 106c and a heating element 107c for heating the third mold material 12c to a molten state. The extruder barrel 105c includes a third nozzle 108c disposed at an end of the third extruder screw 106c for receiving the molten third mold material 12c.

Each of the nozzles 108a-108c of the extruders 102a-102c may be in communication with a corresponding manifold 112a-112c, which provides a passageway for the respective mold materials 12a-12c to an end die 114 of the extrusion system 100. The end die 114 includes an inner portion 114a and an outer portion 114b. The inner portion 114a is received by the outer portion 114b and is moveable relative to the outer portion 114b. For example, the inner portion 114a may be attached or otherwise operably coupled to a screw or other adjustment mechanism to raise and lower the inner portion 114a relative to the outer portion 114b of the end die 114 between an extended state and a retracted state. The inner portion 114a is at least partially spaced apart from the outer portion 114b to define a gap 114c at the end die 114. The gap 114c may be selectively increased or decreased depending on the position of the inner portion 114a relative to the outer portion 114b to adjust a thickness of the mold materials 12a-12c extruded at the end die 114, described in more detail below. Namely, when the inner portion 114a is in the extended state, the gap 114c is increased and, as such, a thickness of the mold materials 12a-12c is increased. Conversely, when the inner portion 114a is in the retracted state, the gap 114c is reduced and, as such, a thickness of the mold materials 12a-12c is reduced. It should be noted that while the inner portion 114a is described as being movable between the extended state and the retracted state, the inner portion 114a could be adjusted to any number of positions between the extended state and the retracted state to adjust the gap 114c to a plurality of different widths. In so doing, the mold materials 12a-12c may be provided with a number of different thicknesses between a largest thickness (i.e., when the inner portion 114a is in the fully extended state) and a smallest thickness (i.e., when the inner portion 114a is in the fully retracted state).

The manifolds 112a-112c are configured to introduce the mold materials 12a-12c to the end die 114 in a sequential manner, whereby the first mold material 12a is provided to the end die 114 upstream of the second mold material 12b, and the second mold material 12b is provided to the end die 114 upstream of the third mold material 12c. The second mold material 12b is layered upon an outer surface of the first mold material 12a to form layers 16a, 16b of a coextruded parison 14 including both materials 12a, 12b. The third mold material 12c is layered upon an outer surface of the second mold material 12b to form layers 16b, 16c of the coextruded parison 14 including both materials 12b, 12c. In other words, the first mold material 12a forms an inner layer 16a of the parison 14 relative to the second mold material 12b and the third mold material 12c, which form outer layers 16b, 16c of the parison 14 relative to the inner layer 16a of the parison 14. While the illustrated example of the extrusion system 100 is configured for coextruding three concentric layers 16a-16c of mold materials 12a-12c, it will be appreciated that molding systems having other configurations may be utilized. For example, the extrusion system 100 may be configured to coextrude a parison 14 including four or more tubular layers 16a-16c. Optionally, the extrusion system 100 may be configured to extrude a parison 14 having a single layer 16a of just the first mold material 12a.

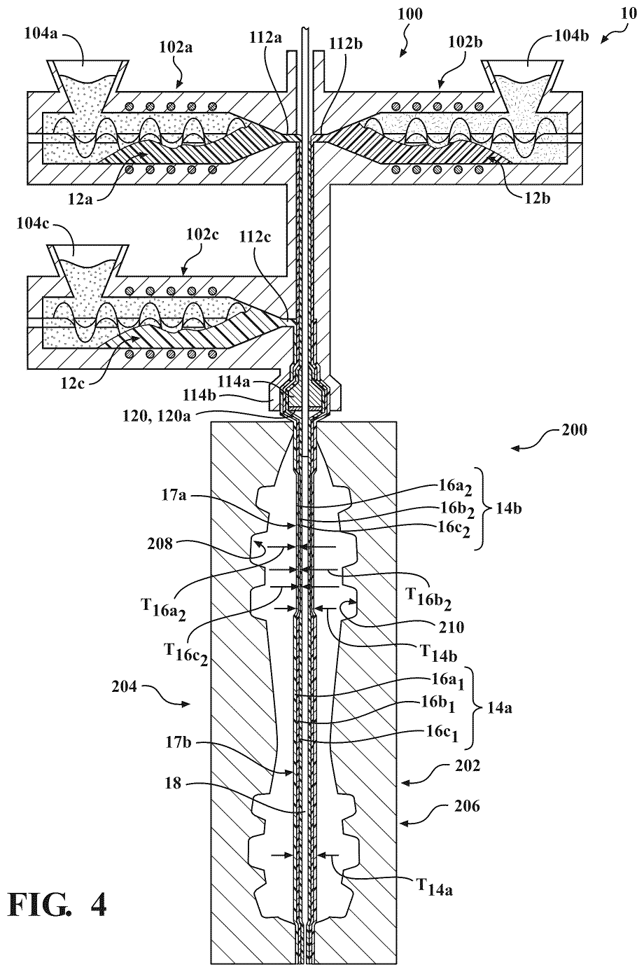

Referring to FIGS. 1-4, the extrusion system 100 includes a blow pin 116 positioned within the end die 114 and extending from an outlet end 115 of the end die 114. The blow pin 116 is configured to extend within an interior cavity 18 of the parison 14 and into the mold system 200. While the illustrated example shows the layers 16a-16c of the parison 14 being directly adjacent to the blow pin 116, other extrusion systems 100 may be configured such that the layers 16a-16c of the parison 14 are spaced radially outwardly from the blow pin 116 and may be separated from the blow pin 116 by a portion of the end die 114 (e.g., an annular spacer). The blow pin 116 is configured to receive a pressurized fluid (e.g., air) and to inject the pressurized fluid into the interior cavity 18 of the parison 14 to expand the parison 14 within the mold system 200, as described below with respect to FIG. 4.

The extrusion system 100 also includes an adjustment element 120, 120a at the outlet end 115 of the end die 114 and at the inner portion 114a of the end die 114. The adjustment element 120 may have various shapes and configurations, described herein. For example, the adjustment element 120 illustrated in FIG. 2A is round or having a circular shape, such that the adjustment element 120 provides a uniform circumferential thickness T₁₄ of the parison 14. Another example adjustment element 120a is illustrated in FIG. 2B and includes an oblong or oval shape.

The adjustment element 120a has ends 124a that can be utilized to adjust or otherwise alter the mold materials 12a-12c while being coextruded as the parison 14. The ends 124a result in a reduced thickness T₁₄ of the parison 14 at the ends 124a of the adjustment element 120a as compared to the uniform thickness T₁₄ formed as a result of the adjustment element 120. For example, the ends 124a of the adjustment element 120a close the gap 114c defined between the inner portion 114a and the outer portion 114b of the end die 114, whereas sides 126a of the adjustment element 120a maintain the gap 114c. Thus, the thickness T₁₄ of the parison 14 is altered (i.e., lessened) as the mold materials 12a-12c pass over the ends 124a of the adjustment element 120a.

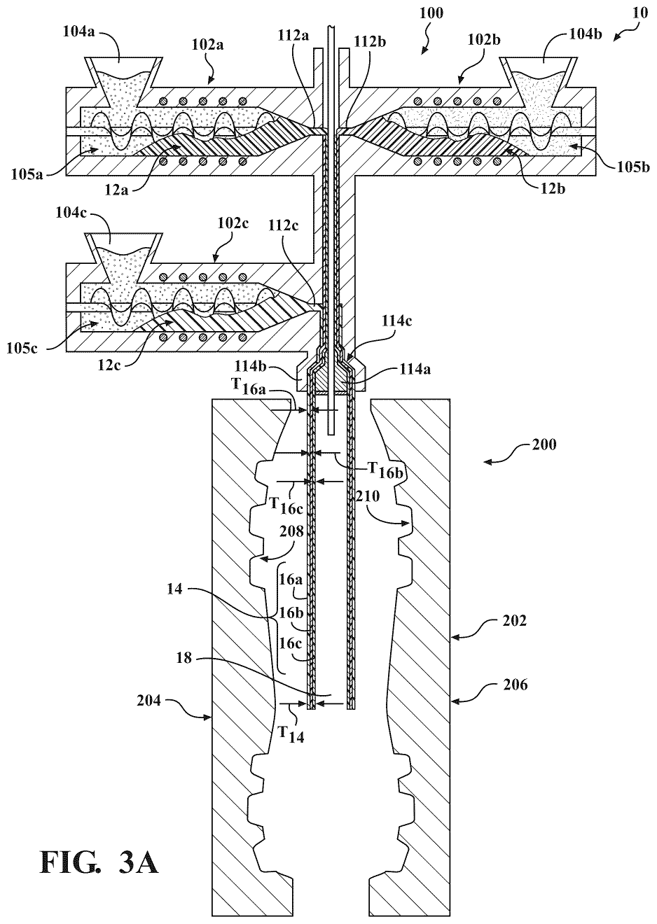

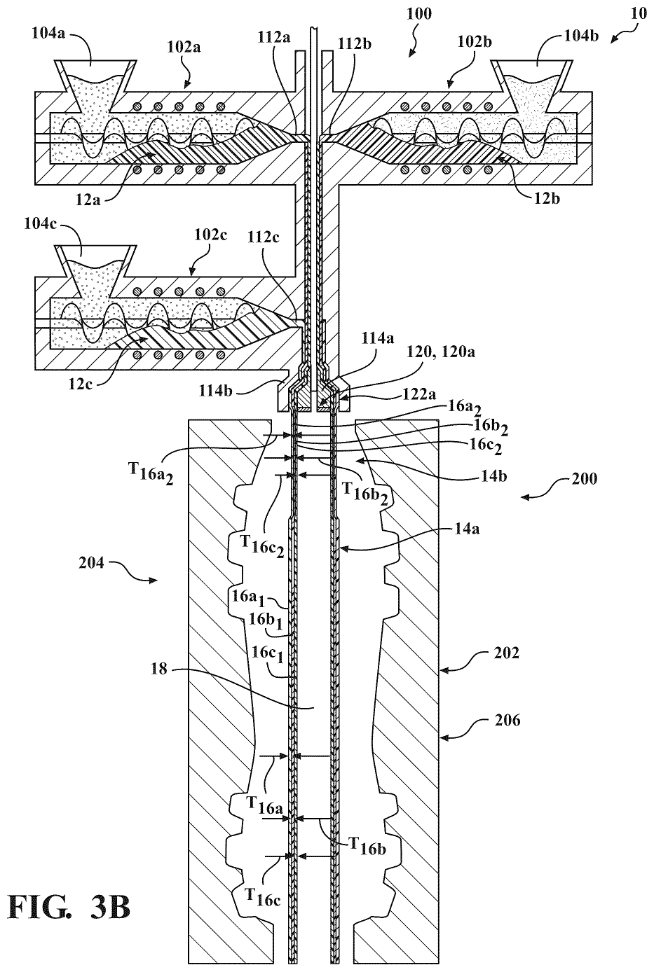

With further reference to FIGS. 1-4 and as mentioned above, the inner portion 114a of the end die 114 is operable between a raised position 122a and a lowered position 122b to adjust the gap 114c and define varied thicknesses T₁₆ₐ-T_{16c} of the layers 16a-16c. For example, FIG. 3B illustrates the inner portion 114a in the raised position 122a, such that the parison 14 may include a first portion 14a including the layers 16a₁-16c₁ having a first thickness T₁₆ₐ₁-T_{16c1} and a second portion 14b including the layers 16a₂-16c₂ having a second thickness T₁₆ₐ₂-T_{16c2}. In this example, the first thickness T₁₆ₐ₁-T_{16c1} is greater than the second thickness T₁₆ₐ₂-T_{16c2}. The layers 16a-16c may thus be modified or otherwise defined by the adjustment element 120, 120a and the positions 122a, 122b of the inner portion 114a of the end die 114.

For example, if the adjustment element 120 is selected, the adjustment element 120 may define a uniform circumferential thickness, and the inner portion 114a may be adjusted to selectively define a thickness T₁₆ₐ-T_{16c} of the layers 16a-16c during the extrusion process. If the adjustment element 120a is selected, the ends 124a of the adjustment element 120a provide a larger surface area to stretch the mold material 12a-12c as it passes through the outlet end 115 to form the parison 14. Thus, the ends 124a of the adjustment element 120a define one or more thin regions 17a of the layers 16a-16c of the parison 14.

The inner portion 114a may be used in combination with the adjustment element 120a to further adjust the thickness T₁₆ₐ-T_{16c} of the layers 16a-16c by raising and lowering the inner portion 114a. For example, the first portion 14a of the parison 14 has a first thickness T₁₄ₐ defined by the lowered position 122b of the inner portion 114a, and the second portion 14b of the parison 14 has a second thickness T_{14b} defined by the raised position 122a of the inner portion 114a. The first thickness T₁₄ₐ generally corresponds to thick regions 17b of the layers 16a-16c, and the second thickness T_{14b} generally corresponds to the thin regions 17a of the layers 16a-16c. The first thickness T₁₄ₐ may, thus, be greater than the second thickness T_{14b}.

In some example configurations, the extrusion system 100 can be a co-extrusion system configured to produce a multi-layer parison 14. For instance, the system 100 may employ a co-extrusion head, such as a 90 mm single parison head, capable of processing multiple material layers simultaneously. This head may be configured to produce a parison with a significant number of layers, for example, seven, eight, or even more distinct layers. The extrusion system 100 can be adapted to include extruders of varying sizes to accommodate different material requirements for each layer of the parison 14. For example, a main extruder, which may be a larger extruder, could be used for a primary interior layer. Smaller extruders may be used for the inner and outer layers 16a, 16b, while other intermediate layers could be supplied by even smaller extruders. To ensure proper processing and extrusion of the various materials 12a-12c, the extruders 102a-102c may be equipped with different types of extruder screws. For many of the layers, general-purpose polyethylene (PE) screws may be suitable. However, for certain specialized layers, such as barrier layers designed to prevent material migration or provide specific mechanical properties, specialized barrier screws may be employed to ensure optimal melt quality and layer formation.

As set forth above, the extrusion system 100 is configured to coextrude the materials 12a-12c. While the materials 12a-12c may be the same, an advantage of the extrusion system 100 is that it allows different materials to be coextruded as unique layers of the parison 14. The layers 16a-16c of the parison 14 can comprise an elastomeric material that includes one or more thermoplastic polymers and/or one or more cross-linkable polymers. In an aspect, the elastomeric material can include one or more thermoplastic elastomeric materials, such as one or more thermoplastic polyurethane (TPU) copolymers, one or more ethylene-vinyl alcohol (EVOH) copolymers, and the like.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldiphenyl-4,4′-diisocyanate (DDDI), 4,4′-dibenzyl diisocyanate (DBDI), 4-chloro-1,3-phenylene diisocyanate, and combinations thereof. In some embodiments, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layers can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), high-density polyethylene, polyethylene terephthalate, polyether imides, polyacrylic imides, and other polymeric materials. Blends of these materials as well as with the TPU copolymers described herein and optionally including combinations of polyimides and crystalline polymers, are also suitable.

In some examples, where a first material 12a, a second material 12b, and/or a third material 12c are selected that are incompatible (e.g., do not naturally bond to each other in a molten state), the extrusion system 100 may include an intermediate extruder configured to extrude an intermediate adhesive material for bonding the first material 12a to the second material 12b and the second material 12b to the third material 12c. Thus, the parison 14 may comprise two or more layers (multilayer extrusion) joined by an adhesive. Additionally or alternatively, extrusion system 100 may include one or more extruders configured to extrude an adhesive material adjacent to the exposed surfaces of the inner layer 16a and/or the outer layers 16b, 16c. For example, an adhesive layer may be extruded and applied to an exposed surface of the inner layer 16a corresponding to a footbed of the sole plate 306, 308, whereby the adhesive enables adhesion of the sole plate 306, 308 to an upper (e.g., to the strobel). Optionally, an adhesive layer may be extruded and applied to an exposed surface of the outer layer 16c corresponding to a ground-engaging surface of the sole plate 306, 308, whereby the adhesive enables adhesion of one or more traction elements to the ground-engaging surface of the sole plate 306, 308. In further configurations, the parison 14 may comprise alternating layers of one or more first copolymer materials and one or more second copolymer materials, where the total number of layers in the parison 14 includes at least four (4) layers, and/or at least ten (10) layers.

In some examples, the first material 12a or the second material 12b may include recycled or upcycled materials, which may be obtained from reclaimed scrap of prior extrusions. Recycled material is understood to be distinguishable from “virgin” materials that have never been utilized in a manufacturing process. Upcycled material is understood to be materials that are repurposed without being broken down into raw materials. In configurations utilizing a recycled or reclaimed material, the parison 14 may be formed with four or more layers 16a-16c, including inner and outer layers 16a-16c including virgin first material 12a or second material 12b and an intermediate layer including the recycled second material interposed between the inner and outer layers 16a-16c. Thus, the parison 14 and the resulting sole plates 306, 308 will include a portion of recycled material concealed between virgin material layers 16a-16c. Thus, the resulting sole plates 306, 308 provide the benefits of using sustainable materials while maintaining the exterior aesthetics associated with virgin materials.

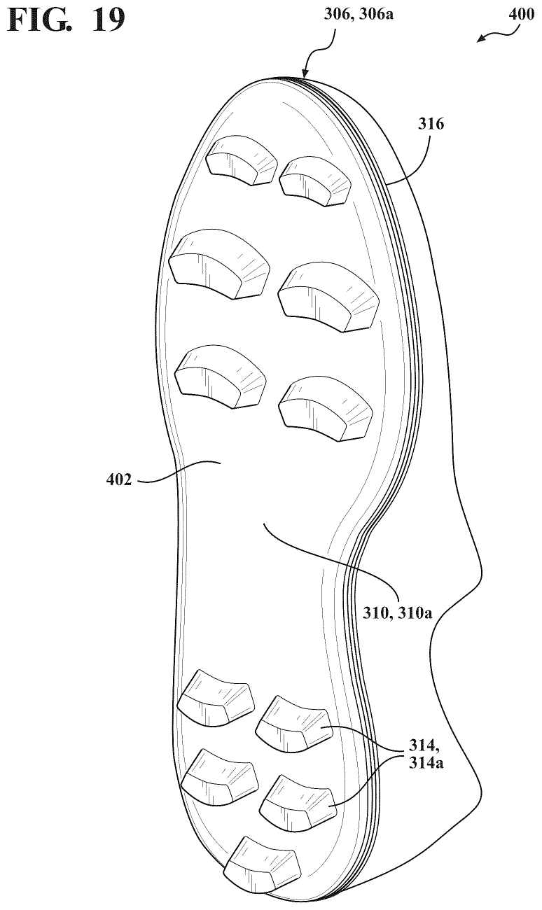

Referring still to FIGS. 1 and 1A, the blow molding system 10 further includes a mold system 200 including a mold assembly 202 operable between an open configuration (FIG. 2A) and a closed configuration (FIG. 4). The mold assembly 202 includes a first mold plate 204 and a second mold plate 206, which are configured to interface with each other in the closed configuration to define a mold chamber 205 configured to receive the parison 14. The first mold plate 204 defines a first mold cavity 208 corresponding to the profile of a first sole plate 306 to be molded using the blow molding system 10. The second mold plate 206 defines a second mold cavity 210 corresponding to the profile of a second sole plate 308 to be molded using the blow molding system 10. For example, the mold cavities 208, 210 may define a profile of a sole component 402 of the article of footwear 400 (FIG. 19). In the illustrated example, the first mold cavity 208 and the second mold cavity 210 are mirror images of each other, whereby the first mold cavity 208 is configured for molding a first sole plate 306 corresponding to a left-footed article of footwear and the second mold cavity 210 is configured for molding a second sole plate 308 corresponding to a right-footed article of footwear. Thus, the mold assembly 202 is configured to simultaneously mold a pair of the mold plates 204, 206 for a single pair of footwear. In other examples, the mold cavities 208, 210 may have the same configuration (e.g., both left-footed) or may have different profiles (e.g., different sizes, shapes, and/or arrangements of traction elements). Further, while the illustrated example shows mold plates 204, 206 each defining a single mold cavity 208, 210, the mold plates 204, 206 may be configured to include two or more of the mold cavities 208, 210. Further, while the mold cavities 208, 210 of the illustrated example are provided as “female” or negative mold cavities, the mold plates 204, 206 may include “male” or positive mold geometries.

The mold plates 204, 206 are configured to interface with each other in the closed configuration (FIG. 3) to form a peripheral seal 211 around the parison 14. Thus, a peripheral portion of the parison 14 may be compressed between the mold plates 204, 206 when the mold plates 204, 206 are in the closed configuration. As shown, the mold plates 204, 206 are also configured to form a peripheral seal 211 between the blow pin 116 and the parison 14 at an entry to the mold chamber 205 to prevent fluid from escaping the mold chamber 205 during the blow molding process.

Referring to FIGS. 2A and 2B, a first step for forming a molded article 300 according to the present disclosure is shown. In FIGS. 2A and 2B, the mold assembly 202 is initially provided in the open configuration, whereby the mold plates 204, 206 are spaced apart from each other to open the mold chamber 205. The extrusion system 100 extrudes the parison 14 including the one or more layers 16a-16c of materials 12a-12c between the mold plates 204, 206 and through the mold chamber 205. As shown, a distal end of the parison 14 extends beyond the mold chamber 205 and is aligned with ends of the mold plates 204, 206.

At FIG. 4, the mold assembly 202 is moved to the closed configuration to form the peripheral seal 211 around the parison 14. As shown, the distal end of the parison 14 is compressed between the mold plates 204, 206 to seal the interior cavity 18 at the distal end of the parison 14. Concurrently, the mold plates 204, 206 interface at a proximal end (i.e., adjacent to the end die 114) of the parison 14 to form the peripheral seal 211 around the parison 14 and the blow pin 116. Thus, at FIG. 4, the parison 14 is sealed at each of the distal end and the proximal end, whereby fluid can be introduced into the interior cavity 18 of the parison 14 via the conduit 118 of the blow pin 116 to expand the parison 14 into the mold plates 204, 206.

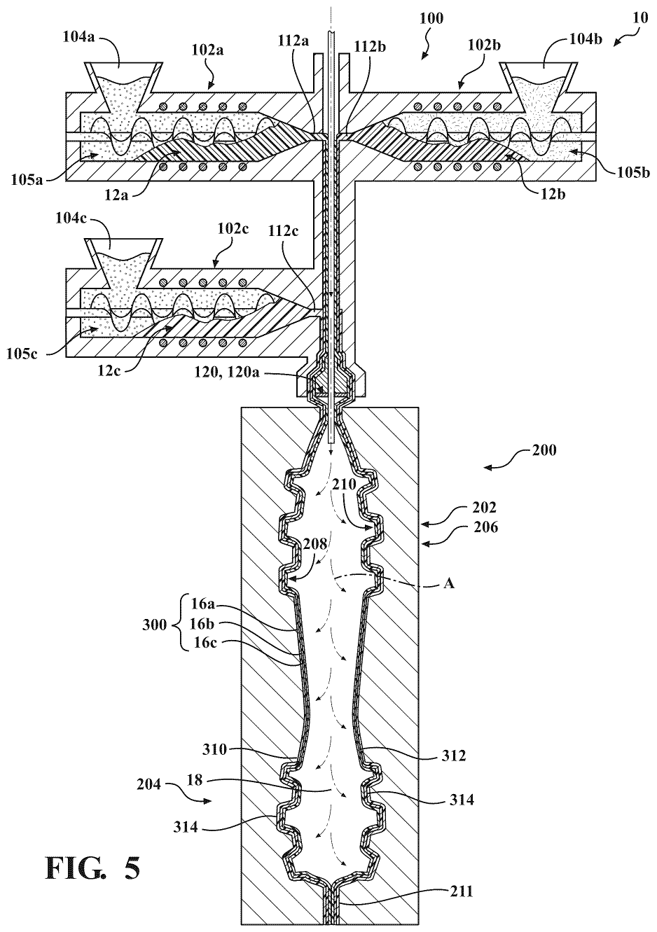

At FIG. 4, compressed air A or other pressurized fluid is introduced into the interior cavity 18 of the parison 14 via the blow pin 116 to bias the layers 16a-16c of the materials 12a-12c of the parison 14 outwardly and into the respective mold cavities 208, 210. As shown, the mold cavities 208, 210 of the illustrated example are configured to form a molded article 300 including sole plates 306, 308 having molded traction elements 314. Particularly, the first mold cavity 208 is configured to form a first sole plate 306 including a first sole plate body 310 and a plurality of the traction elements 314. The second mold cavity 210 is configured to form a second sole plate 308 including a second sole plate body 312 and a plurality of the traction elements 314. At FIG. 5, the mold assembly 202 is moved to the open configuration so that the molded article 300 including the sole plates 306, 308 can be cooled and removed from the mold chamber 205.

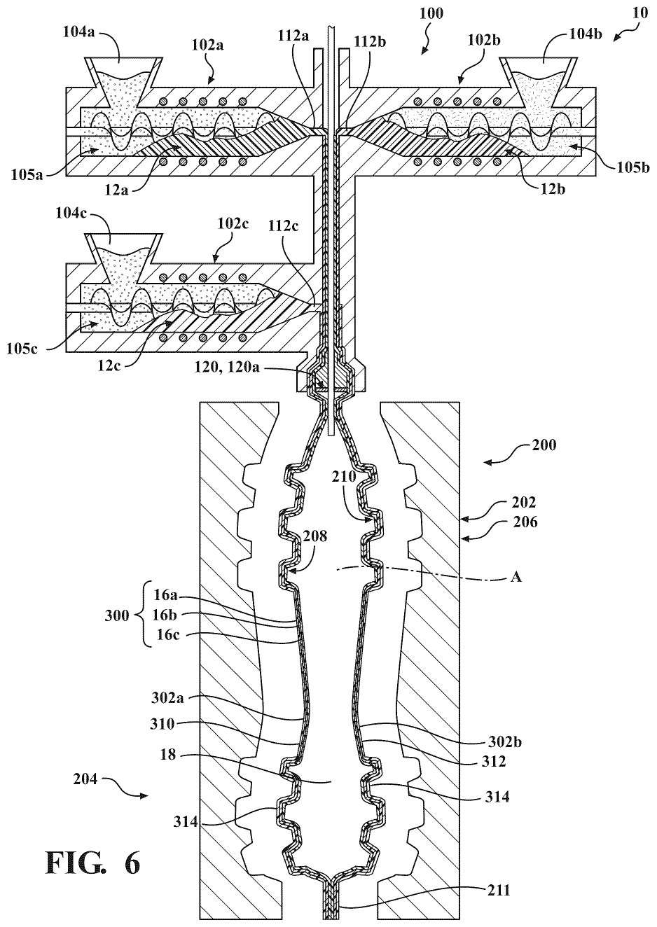

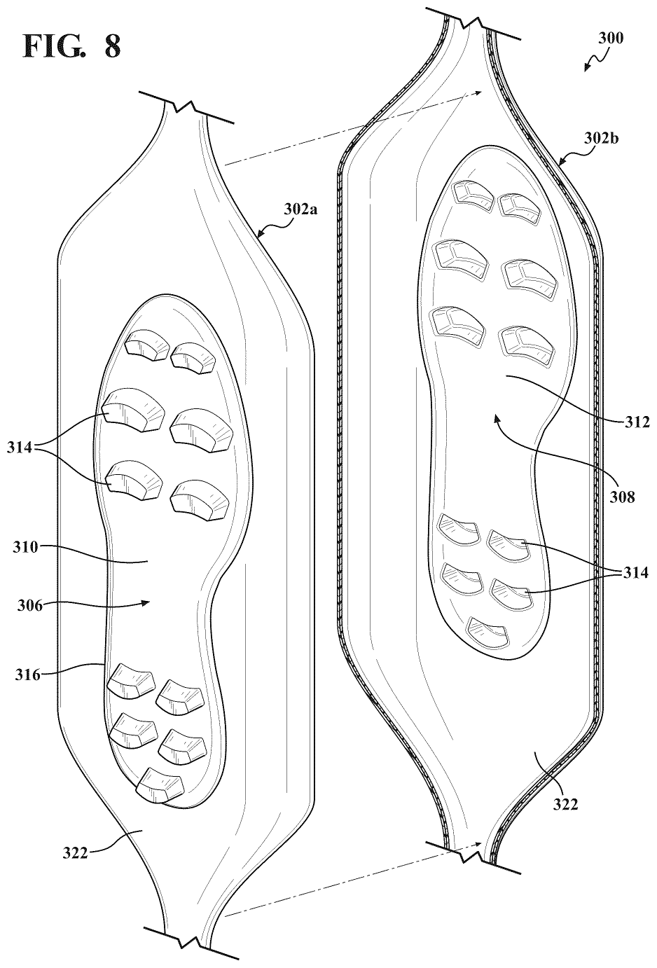

Referring to FIG. 6, the molded article 300 is shown after removal from the mold chamber 205. In this example, the molded article 300 includes a plurality of molded article sections 302a, 302b corresponding to the number of mold plates 204, 206. Thus, the molded article 300 may include a first molded article section 302a and a second molded article section 302b joined to each other at molded article seams 304a, 304b corresponding to the joints between the mold plates 204, 206. The first molded article section 302a includes the first sole plate 308 and mold material flashing 322 associated with excess mold material of the parison 14. The second molded article section 302b includes the second sole plate 308 and mold material flashing 322 associated with excess mold material of the parison 14. As shown, the molded article seams 304a, 304b are formed within the mold flashing 322 between adjacent ones of the molded article sections 302a, 302b. Optionally, the molded article sections 302a, 302b may be separated from each other along the molded article seams 304a, 304b using a cutting tool 20. While the illustrated example shows a manual cutting tool 20 (e.g., a knife), the blow molding system 10 may include automated cutting tools, such as a die cutting device or a computer numerical control (CNC) cutting system. FIG. 8 shows the molded article 300 in a separated state including the first molded article section 302a and the second molded article section 302b.

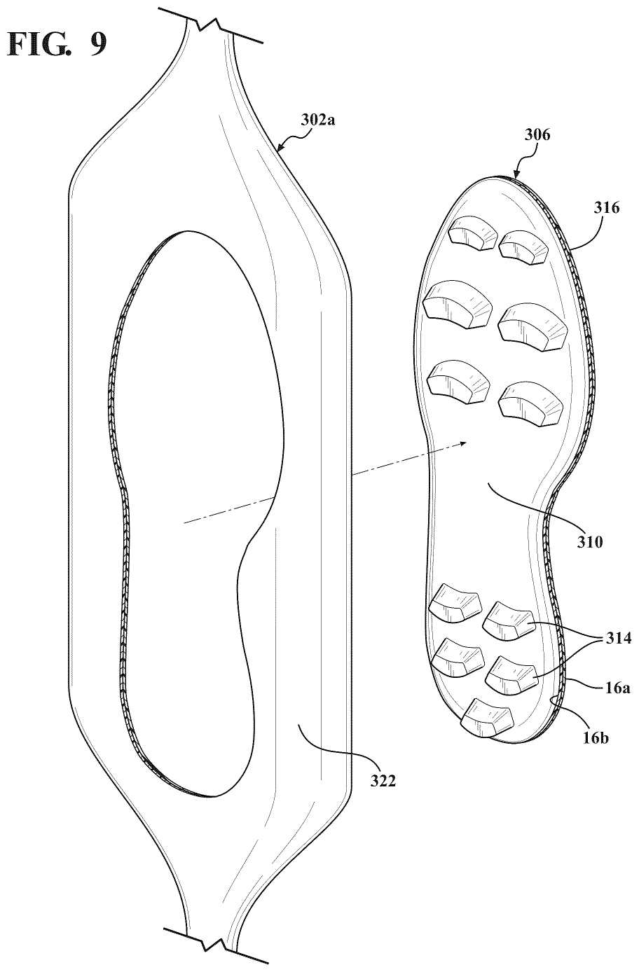

Referring to FIG. 9, the first molded article 302a is shown in isolation for post-mold processing. In this step, the first sole plate 306 is separated from the first molded article section 302a by removing the mold flashing 322 from a first plate body periphery 316. As shown, the first sole plate 306 includes each of the layers 16a-16c of the parison 14, which cooperate to define the structure of the sole plate 306. In other words, the layers 16a-16c are provided collectively to form the structure of the parison 14. The illustrated sole plate 306 includes a first sole plate body 310 and a plurality of traction elements 314, each including the layers 16a-16c. Again, while the illustrated examples of the sole plates 306, 308 are provided with three layers 16a-16c, any number of material layers may be incorporated into the sole plates 306, 308 by selecting a corresponding extrusion system 100 for forming a parison 14 with the desired layer configuration. Additionally or alternatively, thicknesses T₁₆ₐ-T_{16c} of the layers 16a-16c may be varied and/or the layers 16a-16c may be intermittently provided in independent zones of the sole plates 306, 308.

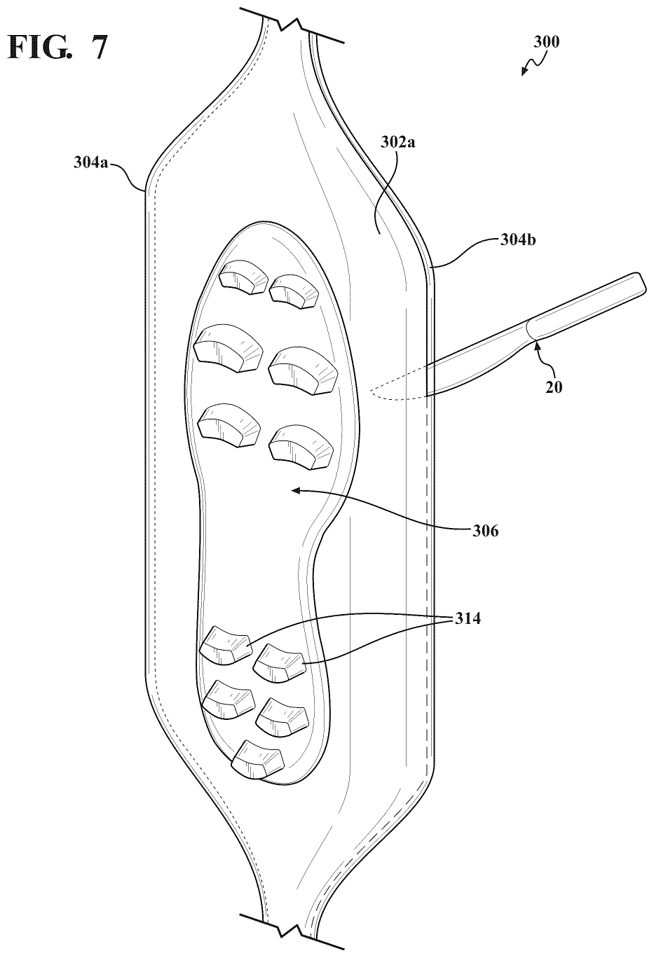

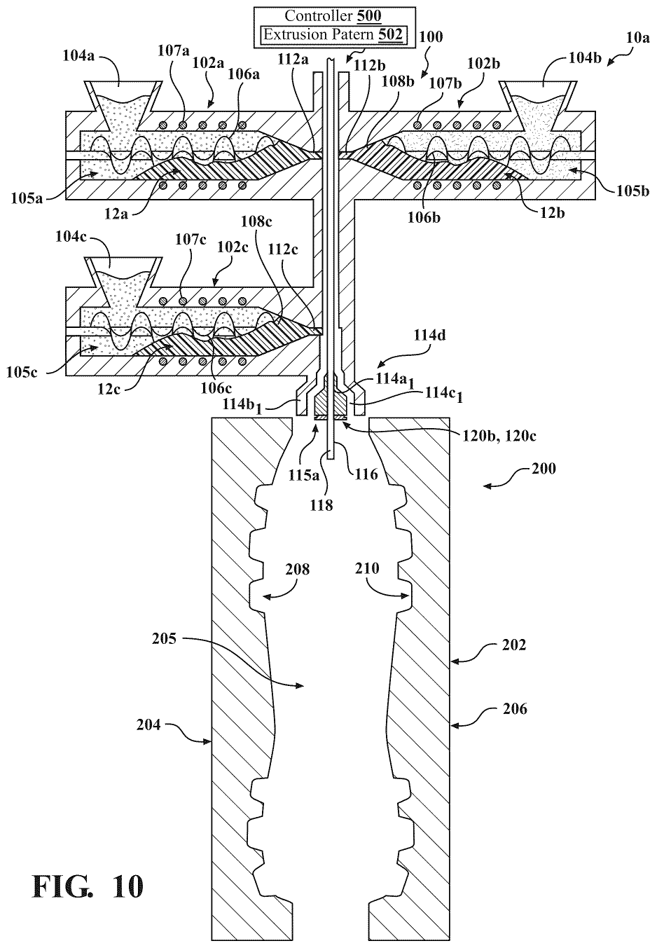

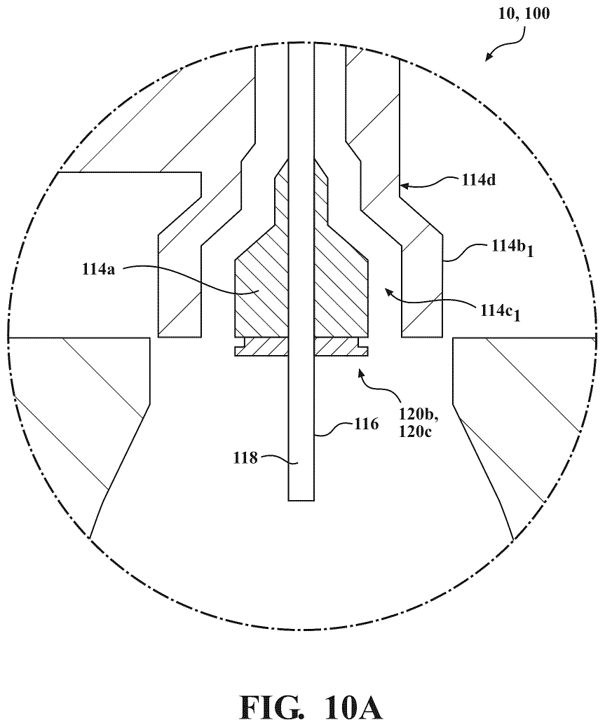

With particular reference to FIGS. 10-19, another example of use of a blow molding system 10a is provided. In view of the substantial similarity in structure and function of the components associated with the blow molding system 10 of FIGS. 1-9 with respect to the blow molding system 10a of FIGS. 10-19, like reference numerals are used hereinafter and in the drawings to identify like components while like reference numerals containing letter and/or number extensions are used to identify those components that have been modified.

As discussed above, the blow molding system 10a may be configured to intermittently extrude one or more of the layers 16a₁-16c₁ to provide variable properties in the sole plates. The blow molding system 10a includes an extrusion system 100a and a mold system 200 configured to produce a blow-molded article 300 including a plurality of sole plates 306, 308 for use in manufacturing of an article of footwear 400. Thus, the plurality of the sole plates 306, 308 can be simultaneously formed by the blow molding system 10a.

Referring to FIGS. 10-13, the extrusion system 100a includes one or more extruders 102a-102d, including a first extruder 102a configured to extrude a first mold material 12a, a second extruder 102b configured to extrude a second mold material 12b, and a third extruder 102c configured to extrude a third mold material 12c. In this configuration, the second material 12b may be encapsulated or interposed between the first mold material 12a and the third mold material 12c. While the illustrated example is provided with first, second, and third extruders 102a-102c, for the sake of clarity, it should be appreciated that the extrusion system 100a may include less extruders or additional extruders as desired.

The first extruder 102a includes a first hopper 104a for receiving the first mold material 12a in a raw form, such as in a pellet form. The first extruder 102a further includes an extruder barrel 105a including a first extruder screw 106a and a heating element 107a for heating the first mold material 12a to a molten state. The extruder barrel 105a includes a first nozzle 108a disposed at an end of the first extruder screw 106a for receiving the molten first mold material 12a.

The second extruder 102b includes a second hopper 104b for receiving the second mold material 12b in a raw form, such as in a pellet form. The second extruder 102b further includes an extruder barrel 105b including a second extruder screw 106b and a heating element 107b for heating the second mold material 12b to a molten state. The extruder barrel 105b includes a second nozzle 108b disposed at an end of the second extruder screw 106b for receiving the molten second mold material 12b.

The third extruder 102c includes a third hopper 104c for receiving the third mold material 12c in a raw form, such as in a pellet form. The third extruder 102c further includes an extruder barrel 105c including a third extruder screw 106c and a heating element 107c for heating the third mold material 12c to a molten state. The extruder barrel 105c includes a third nozzle 108c disposed at an end of the third extruder screw 106c for receiving the molten third mold material 12c.

Each of the nozzles 108a-108c of the extruders 102a-102c may be in communication with a corresponding manifold 112a-112c, which provide a passageway for the respective mold materials 12a-12c to an end die 114d of the extrusion system 100a. The end die 114d includes an inner portion 114a1 and an outer portion 114b1. The inner portion 114a1 is received by the outer portion 114b1 and is moveable relative to the outer portion 114b1. For example, the inner portion 114a1 may be attached or otherwise operably coupled to a screw or other adjustment mechanism to raise and lower the inner portion 114a relative to the outer portion 114b1 of the end die 114d. The inner portion 114a1 is at least partially spaced apart from the outer portion 114b1 to define a gap 114c1 at the end die 114d. The gap 114c1 may be selectively increased or decreased depending on the position of the inner portion 114a1 relative to the outer portion 114b1 to adjust a thickness of the mold materials 12a, 12b extruded at the end die 114d.

The manifolds 112a-112c are configured to introduce the mold materials 12a-12c to the end die 114 in a sequential manner, whereby the first mold material 12a is provided to the end die 114 upstream of the second mold material 12b, and the second mold material 12b is provided to the end die 114 upstream of the third mold material 12c. The second mold material 12b is layered upon an outer surface of the first mold material 12a to form layers 16a1, 16b1 of a coextruded parison 14c including both materials 12a, 12b. The third mold material 12c is layered upon an outer surface of the second mold material 12b to form layers 16b1, 16c1 of the coextruded parison 14c including both materials 12b, 12c. In other words, the first mold material 12a forms an inner layer 16a1 of the parison 14c relative to the second mold material 12b and the third mold material 12c, which form outer layers 16b₁, 16c₁ of the parison 14c relative to the inner layer 16a of the parison 14c. While the illustrated example of the extrusion system 100a is configured for coextruding three concentric layers 16a₁-16c₁ of mold materials 12a-12c, it will be appreciated that molding systems having other configurations may be utilized. For example, the extrusion system 100a may be configured to coextrude a parison 14c including four or more tubular layers 16a₁-16c₁. Optionally, the extrusion system 100a may be configured to extrude a parison 14c having a single layer 16a₁ of just the first mold material 12a.

Referring still to FIGS. 10-13, the extrusion system 100a includes a blow pin 116 positioned within the end die 114d and extending from an outlet end 115a of the end die 114d. The blow pin 116 is configured to extend within an interior cavity 18 of the parison 14c and into the mold system 200. While the illustrated example shows the layers 16a₁-16c₁ of the parison 14c being directly adjacent to the blow pin 116, other extrusion systems 100a may be configured such that the layers 16a₁-16c₁ of the parison 14c are spaced radially outwardly from the blow pin 116 and may be separated from the blow pin 116 by a portion of the end die 114d (e.g., an annular spacer). The blow pin 116 is configured to receive a pressurized fluid (e.g., air) and to inject the pressurized fluid into the interior cavity 18 of the parison 14c to expand the parison 14c within the mold system 200.

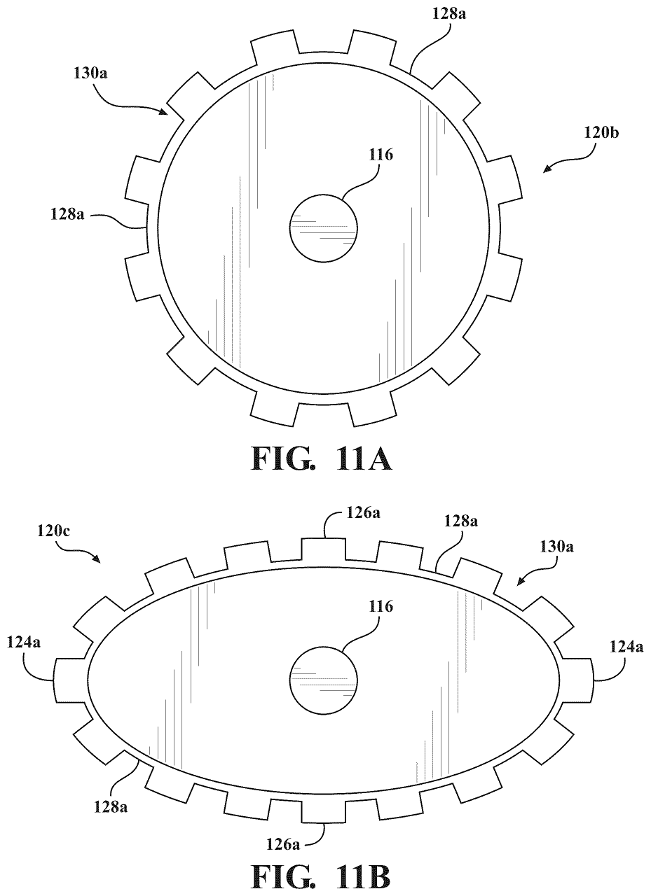

The extrusion system 100a also includes an adjustment element 120b, 120c at the outlet end 115a of the end die 114d. For example, FIG. 11A illustrates a circular or round adjustment element 120b, and FIG. 11B illustrates an oval or eccentric adjustment element 120c. Ends 124a of the adjustment element 120c can be utilized to adjust or otherwise alter the mold materials 12a-12c while being coextruded as the parison 14c. The ends 124a of the adjustment element 120c are configured to define a lesser amount of the mold material 12a-12c at selective portions of the parison 14c. The adjustment elements 120b, 120c may be utilized in combination with the adjustment of the inner portion 114a₁ of the end die 114 to further adjust the thickness T₁₆ₐ₁-T_{16c1} of the layers 16a₁-16c₁. The ends 124a of the adjustment element 120c can be utilized to adjust or otherwise alter the mold materials 12a-12c while being coextruded as the parison 14c. The ends 124a result in a reduced thickness T_{14c} of the parison 14c at the ends 124a of the adjustment element 120c as compared to the uniform thickness T_{14c} formed as a result of the adjustment element 120b. For example, the ends 124a of the adjustment element 120c close the gap 114c₁ defined between the inner portion 114a₁ and the outer portion 114b₁ of the end die 114d, whereas sides 126a of the adjustment element 120c maintain the gap 114c₁. Thus, the thickness T_{14c} of the parison 14c is altered (i.e., lessened) as the mold materials 12a-12c pass over the ends 124a of the adjustment element 120c.

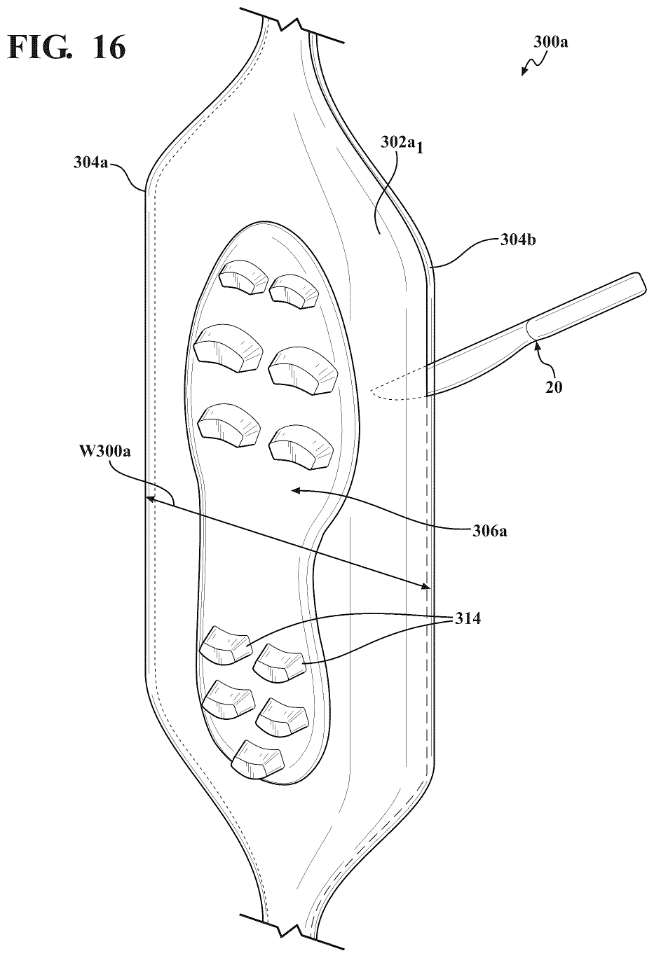

The adjustment elements 120b, 120c also include notches 128a around a periphery 130a of the adjustment elements 120b, 120c. In some instances, the notches 128a may be intermittently defined along the periphery 130a of the adjustment elements 120b, 120c. The notches 128a are configured to gather extra mold material 12a-12c. The extra mold material 12a-12c is gathered within the notches 128a during extrusion of the mold material 12a-12c and may form bands in the layers 16a₃-16c₃. The bands within the layers 16a₃-16c₃ may define a varied thickness T₁₆ₐ₃-T_{16c3} across a width W₃₀₀ₐ (FIG. 16) of the molded article 300a. For example, the notches 128a may align with an axis of where traction elements 314a of the molded article 300a may be formed. Thus, the notches 128a would result in an increased amount of mold material 12a-12c deposited at the area where the traction elements 314a are to be formed.

The thickness T₁₆ₐ₃-T_{16c3} of the layers 16a₃-16c₃ may be further altered via positioning of the inner portion 114a₁ of the end die 114d. For example, the inner portion 114a₁ of the end die 114d is operable between a raised position 122a (FIG. 3B) and a lowered position 122b to adjust the gap 114c₁ and define varied thicknesses T₁₆ₐ₃-T_{16c3} of the layers 16a₃-16c₃. The layers 16a₃-16c₃ may thus be modified or otherwise defined by the adjustment element 120b, 120c and the positions 122a, 122b of the inner portion 114a₁ of the end die 114d. For example, if the adjustment element 120b is selected, the adjustment element 120b may define a generally uniform circumferential thickness, while the notches 128a provide varied bands of thickness, and the inner portion 114a₁ may be adjusted to selectively define a thickness T₁₆ₐ₃-T_{16c3} of the layers 16a₃-16c₃ of a first portion 14a₁ of the parison 14c during the extrusion process. If the adjustment element 120c is selected, the ends 124a of the adjustment element 120c provide a larger surface area to stretch the mold material 12a-12c as it passes through the outlet end 115a to form the parison 14c. Thus, the ends 124a of the adjustment element 120c may define one or more thin regions 17a₁ of the layers 16a₄-16c₄ of a second portion 14b₁ of the parison 14c.

The inner portion 114a₁ may be used in combination with the adjustment element 120c to further adjust the thickness T₁₆ₐ₃-T_{16c3} of the layers 16a₃-16c₃ by raising and lowering the inner portion 114a₁. The inner portion 114a₁ may also be repeatedly adjusted between the raised position 122a and the lowered position 122b to define a variable thickness T₁₄ₐ₁-T_{14b1} of the parison 14c. For example, the parison 14c has a first thickness T₁₄ₐ₁ defined by the lowered position 122b of the inner portion 114a₁ and a second thickness T_{14b1} defined by the raised position 122a of the inner portion 114a₁. The first thickness T₁₄ₐ₁ generally corresponds to the thick regions 17b₁ of the layers 16a₃-16c₃, and the second thickness T_{14b1} generally corresponds to the thin regions 17a₁ of the layers 16a-16c. The first thickness T₁₄ₐ₁ may, thus, be greater than the second thickness T_{14b1}.

As mentioned above, where a first material 12a, a second material 12b, and/or a third material 12c are selected that are incompatible (e.g., do not naturally bond to each other in a molten state), the extrusion system 100 may include an intermediate extruder configured to extrude an intermediate adhesive material for bonding the first material 12a to the second material 12b and the second material 12b to the third material 12c. Thus, the parison 14c may comprise two or more layers (multilayer extrusion) joined by an adhesive. Additionally or alternatively, extrusion system 100 may include one or more extruders configured to extrude an adhesive material adjacent to the exposed surfaces of the inner layer 16a₁ and/or the outer layers 16b₁, 16c₁. For example, an adhesive layer may be extruded and applied to an exposed surface of the inner layer 16a₁ corresponding to a footbed of the sole plate 306, 308, whereby the adhesive enables adhesion of the sole plate 306, 308 to an upper (e.g., to the strobel). Optionally, an adhesive layer may be extruded and applied to an exposed surface of the outer layer 16c₁ corresponding to a ground-engaging surface of the sole plate 306, 308, whereby the adhesive enables adhesion of one or more traction elements to the ground-engaging surface of the sole plate 306, 308. In further configurations, the parison 14 may comprise alternating layers of one or more first copolymer materials and one or more second copolymer materials, where the total number of layers in the parison 14 includes at least four (4) layers, and/or at least ten (10) layers.

In some examples, the first material 12a or the second material 12b may include recycled or upcycled materials, which may be obtained from reclaimed scrap of prior extrusions. Recycled material is understood to be distinguishable from “virgin” materials that have never been utilized in a manufacturing process. In configurations utilizing a recycled or reclaimed material, the parison 14 may be formed with four or more layers 16a₁-16c₁, including inner and outer layers 16a₁-16c₁ including virgin first material 12a or second material 12b and an intermediate layer including the recycled second material interposed between the inner and outer layers 16a-16c. Thus, the parison 14 and the resulting sole plates 306, 308 will include a portion of recycled material concealed between virgin material layers 16a₁-16c₁. Thus, the resulting sole plates 306, 308 provide the benefits of using sustainable materials while maintaining the exterior aesthetics associated with virgin materials.

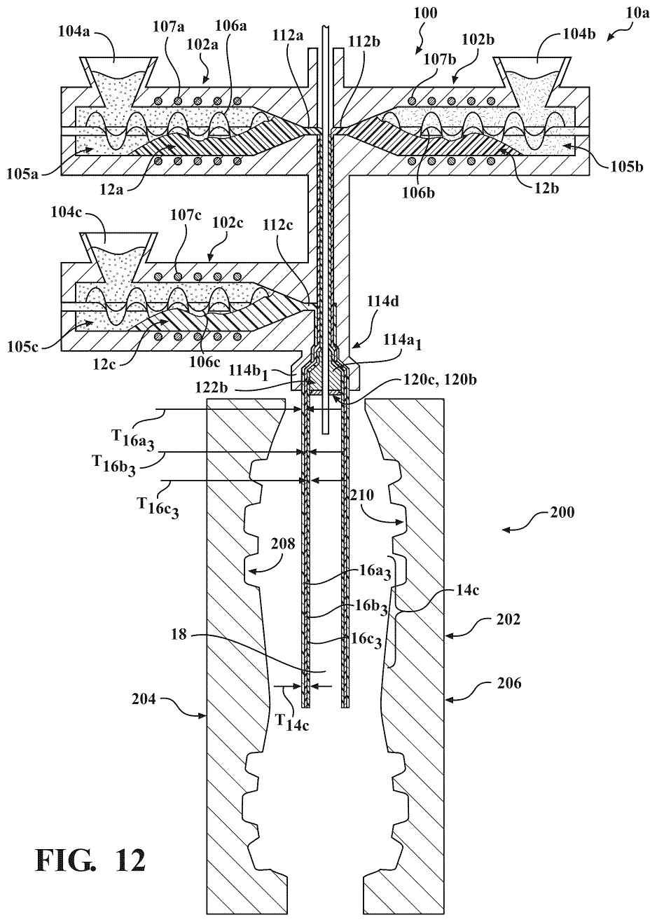

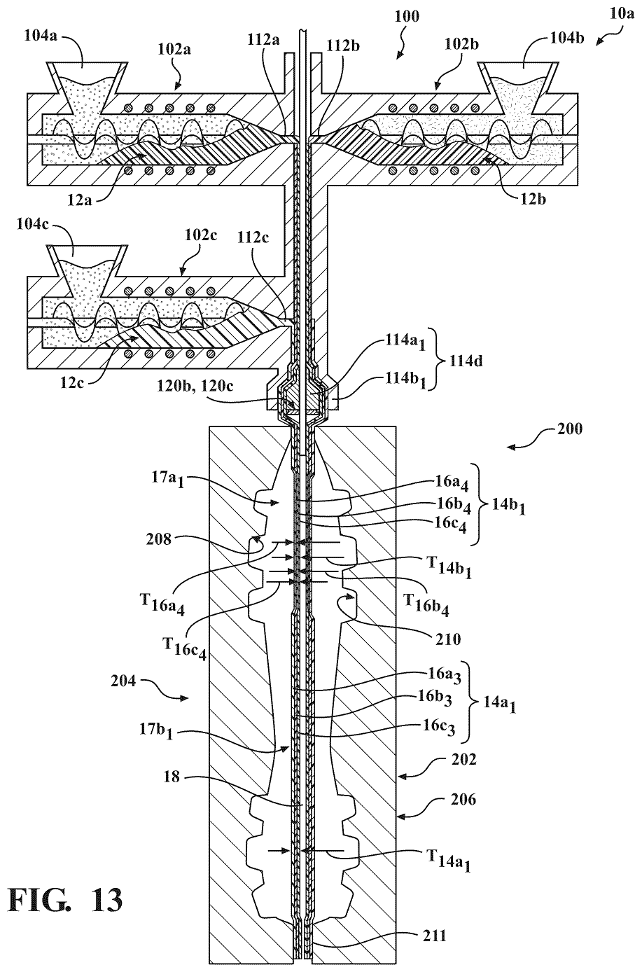

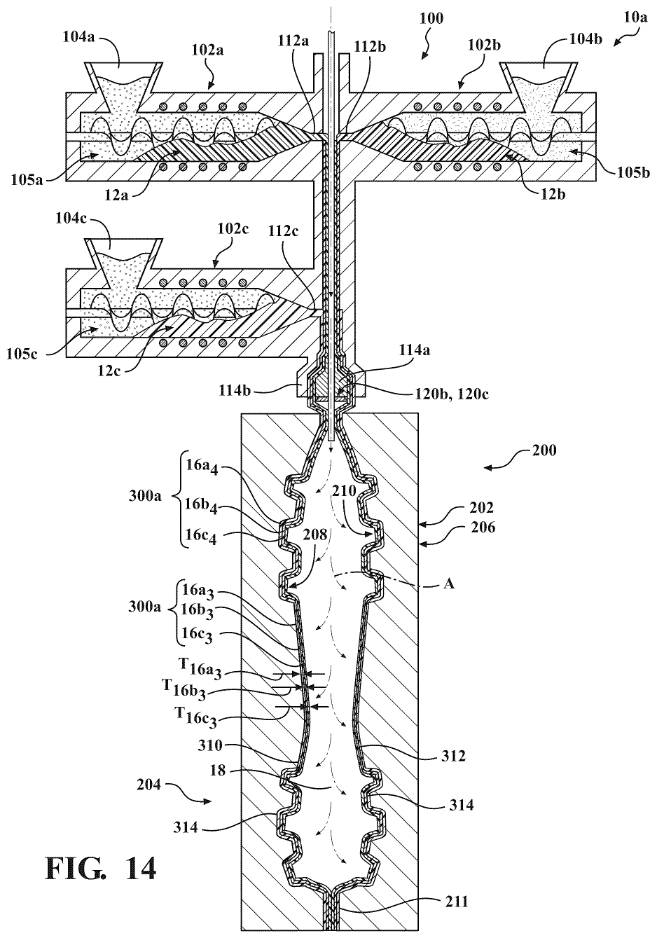

Referring to FIG. 12, a first step for forming a molded article 300a (FIG. 14) according to the present disclosure is shown. In FIG. 12, the mold assembly 202 is initially provided in the open configuration, whereby the mold plates 204, 206 are spaced apart from each other to open the mold chamber 205. The extrusion system 100a extrudes the parison 14 including the one or more layers 16a₁-16c₁ of materials 12a-12c between the mold plates 204, 206 and through the mold chamber 205. As shown at FIG. 13, a distal end of the parison 14c extends beyond the mold chamber 205 and is aligned with ends of the mold plates 204, 206.

At FIG. 13, the mold assembly 202 is moved to the closed configuration to form the peripheral seal 211 around the parison 14c. As shown, the distal end of the parison 14c is compressed between the mold plates 204, 206 to seal the interior cavity 18 at the distal end of the parison 14. Concurrently, the mold plates 204, 206 interface at a proximal end (i.e., adjacent to the end die 114) of the parison 14c to form the peripheral seal 211 around the parison 14c and the blow pin 116. Thus, at FIG. 13, the parison 14c is sealed at each of the distal end and the proximal end, whereby fluid can be introduced into the interior cavity 18 of the parison 14c via the conduit 118 of the blow pin 116 to expand the parison 14c into the mold plates 204, 206.

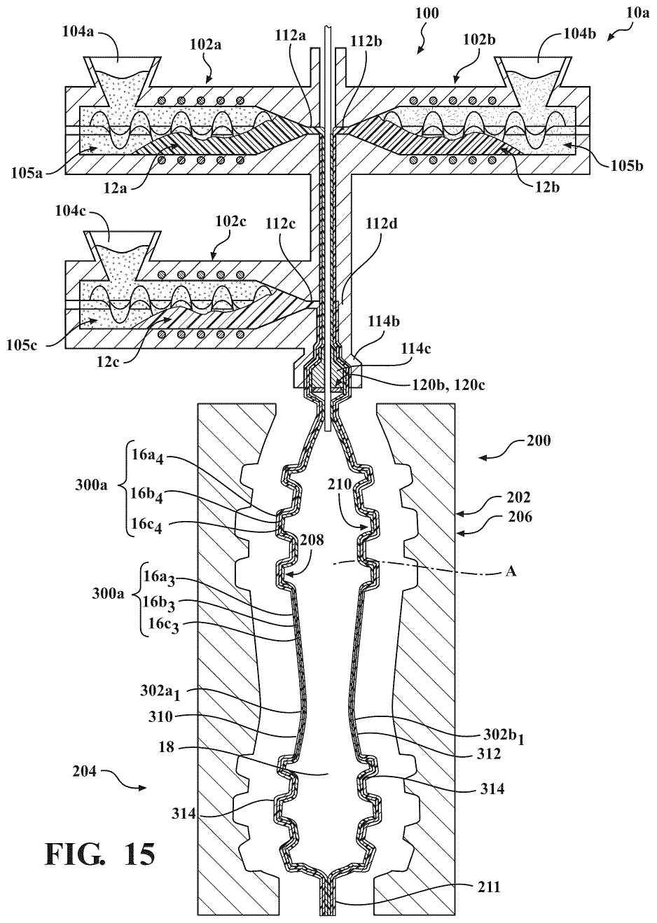

At FIG. 14, compressed air A is introduced into the interior cavity 18 of the parison 14c via the blow pin 116 to bias the layers 16a-16c of the materials 12a-12c of the parison 14c outwardly and into the respective mold cavities 208, 210. As shown, the mold cavities 208, 210 of the illustrated example are configured to form a molded article 300a including sole plates 306a, 308a having molded traction elements 314a. Particularly, the first mold cavity 208 is configured to form a first sole plate 306a including a first sole plate body 310a and a plurality of the traction elements 314a. The second mold cavity 210 is configured to form a second sole plate 308a including a second sole plate body 312a and a plurality of the traction elements 314a. At FIG. 15, the mold assembly 202 is moved to the open configuration so that the molded article 300a including the sole plates 306a, 308a can be cooled and removed from the mold chamber 205.

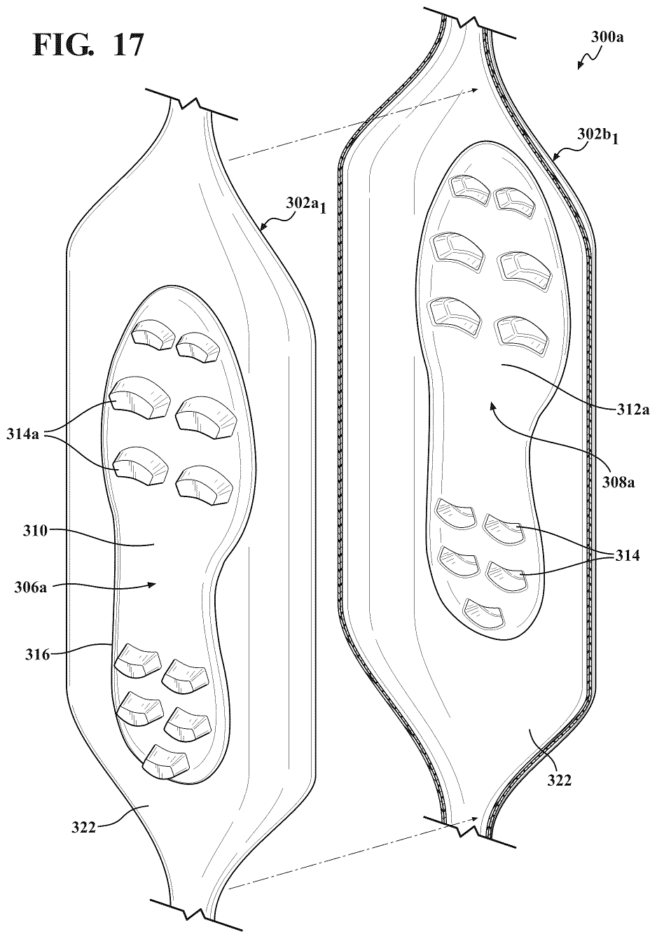

Referring to FIG. 16, the molded article 300a is shown after removal from the mold chamber 205. In this example, the molded article 300a includes a plurality of molded article sections 302a₁, 302b₁ corresponding to the number of mold plates 204, 206. Thus, the molded article 300a may include a first molded article section 302a₁ and a second molded article section 302b₁ joined to each other at molded article seams 304a, 304b corresponding to the joints between the mold plates 204, 206. The first molded article section 302a₁ includes the first sole plate 306a and mold material flashing 322 associated with excess mold material of the parison 14c. The second molded article section 302b₁ includes the second sole plate 308a and mold material flashing 322 associated with excess mold material of the parison 14c. As shown, the molded article seams 304a, 304b are formed within the mold flashing 322a between adjacent ones of the molded article sections 302a₁, 302b₁. Optionally, the molded article sections 302a₁, 302b₁ may be separated from each other along the molded article seams 304a, 304b using a cutting tool 20. While the illustrated example shows a manual cutting tool 20 (e.g., a knife), the blow molding system 10a may include automated cutting tools, such as a die cutting device or a computer numerical control (CNC) cutting system. FIG. 17 shows the molded article 300a in a separated state including the first molded article section 302a₁ and the second molded article section 302b₁.

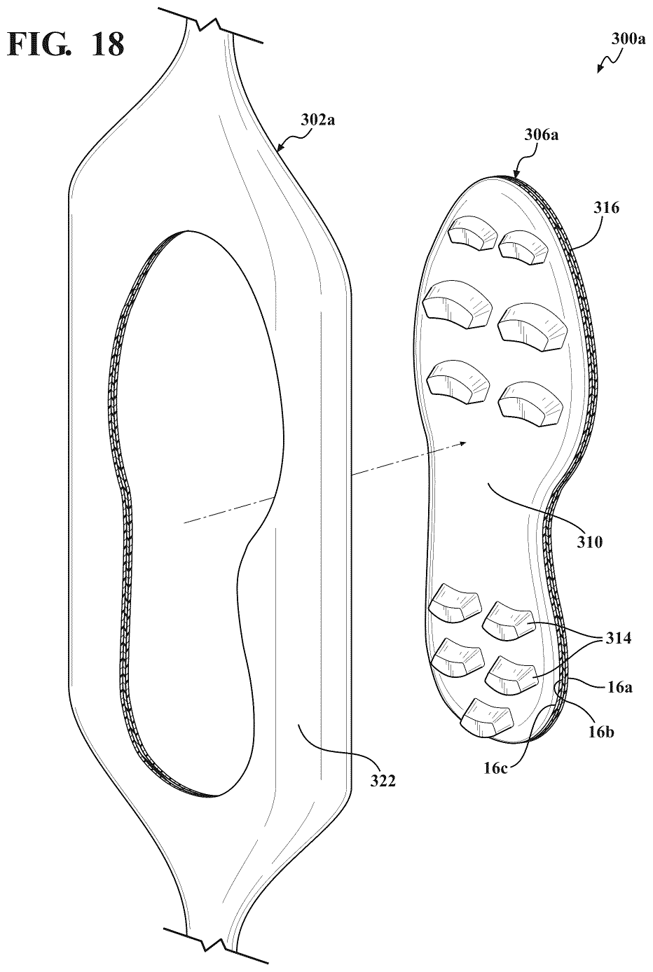

Referring to FIG. 18, the first molded article 302a₁ is shown in isolation for post-mold processing. In this step, the first sole plate 306a is separated from the first molded article section 302a₁ by removing the mold flashing 322 from a first plate body periphery 316. As shown, the first sole plate 306 includes each of the layers 16a₁-16c₁ of the parison 14c, which cooperate to define the structure of the sole plate 306a. The illustrated sole plate 306a includes a first sole plate body 310a and a plurality of traction elements 314a, each including the layers 16a-16c. Again, while the illustrated examples of the sole plates 306a, 308a are provided with three layers 16a₁-16c₁, any number of material layers may be incorporated into the sole plates 306a, 308a by selecting a corresponding extrusion system 100a for forming a parison 14c with the desired layer configuration. Additionally or alternatively, thicknesses T₁₆ₐ₁-T_{16c1} of the layers 16a₁-16c₁ may be varied and/or the layers 16a₁-16c₁ may be intermittently provided in independent zones of the sole plates 306a, 308a. FIG. 19 illustrates an example of an article of footwear 400 equipped with a sole component 402. The sole component 402 may include the molded article 300, 300a described herein.

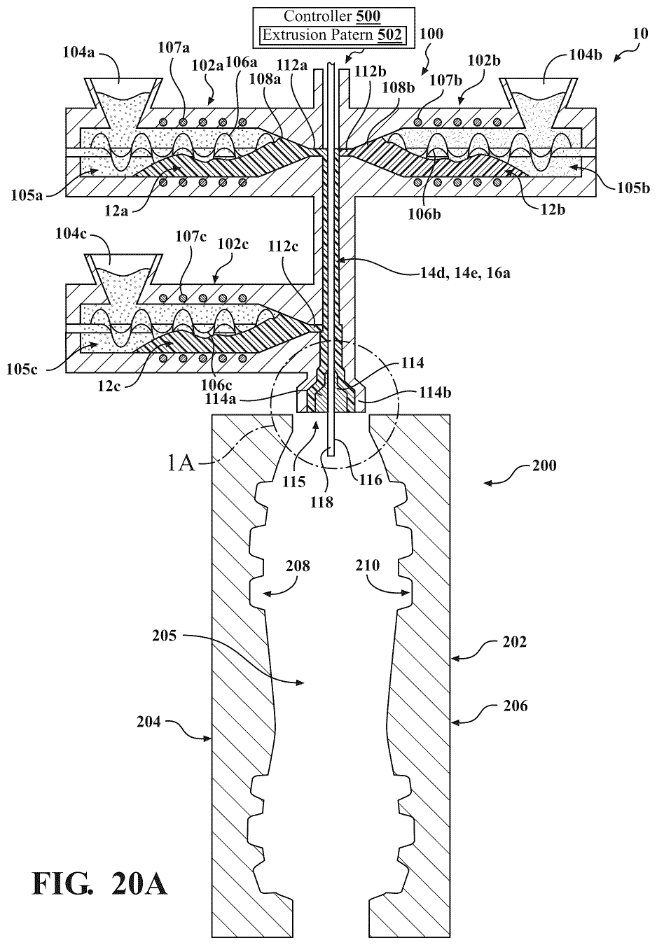

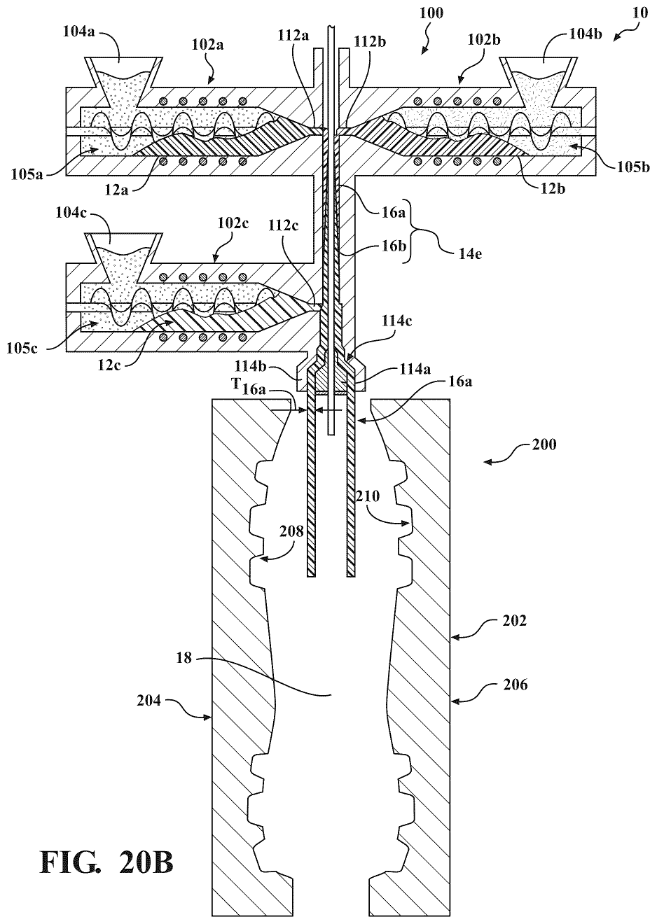

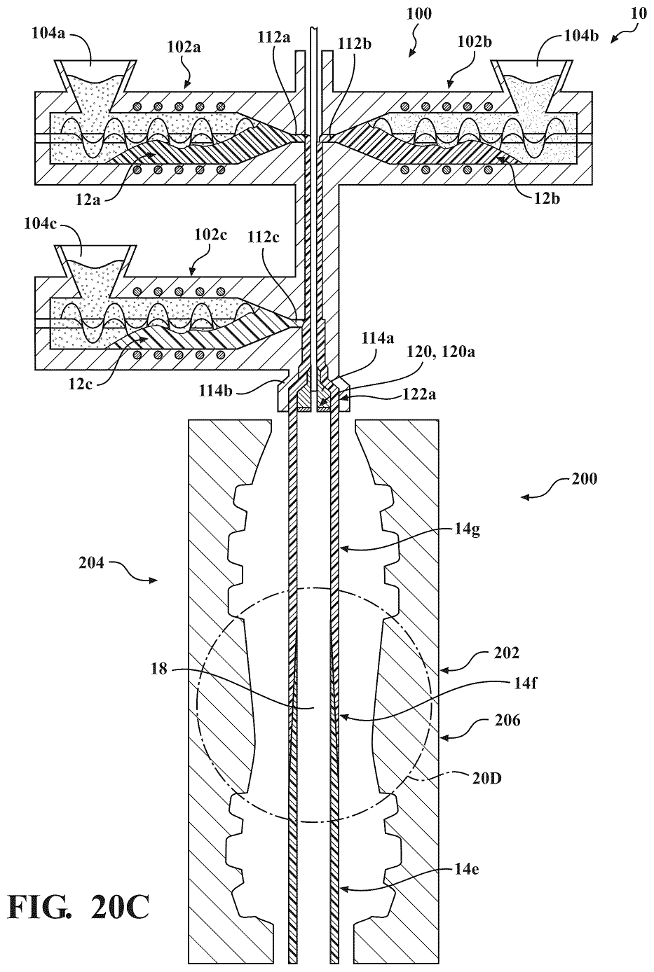

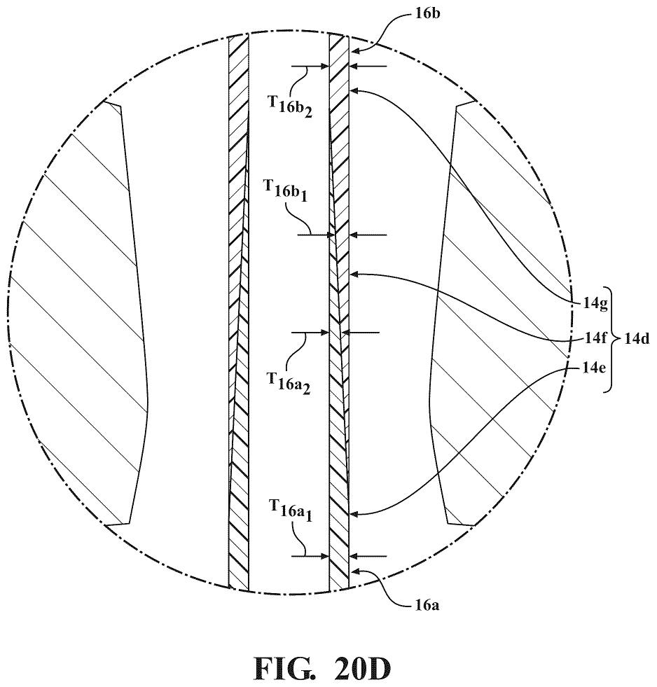

With particular reference to FIGS. 20A-26, another example of use of the blow molding system 10 to form a molded article 300b is provided. In this example, the blow molding system 10 is operated to form a molded article 300b that includes a transitional or gradated appearance. For example, the molded article 300b may be formed with a gradual transition from a first color to a second color along a length (i.e., the extrusion direction) of the molded article. As discussed in the following paragraphs, the molded article 300b is formed by initially extruding a parison 14d including first portion 14e formed of the first mold material 12a, a second portion 14f formed of the first mold material 12a and the second mold material 12b, and third portion 14g formed of the second mold material 12b. In this example, the second portion 14f provides a gradated transition from the first mold material 12a to the second mold material 12b.

Referring to FIG. 20A, the controller 500 may initially operate the first extruder 102a to extrude a first portion 14e of the parison 14d, which includes a first layer 16a formed of the first mold material 12a. Referring to FIG. 20B, to form the second portion 14f, the controller 500 can be configured to create a gradated transition from the first mold material 12a to the second mold material 12b. This gradation may be formed by adjusting the operational speeds of the extruders 102a, 102b. For example, the controller 500 may execute a predetermined extrusion pattern 502 where the speed of the first extruder 102a is gradually decreased while the speed of the second extruder 102b is simultaneously and gradually increased. This creates the second portion 14f of the parison 14d, which has a material composition that transitions from 100% of the first mold material 12a to 100% of the second mold material 12b. As shown in FIG. 20C, once the transition is complete, the controller 500 may stop the first extruder 102a and operate only the second extruder 102b to form the third portion 14g of the parison, which includes the second layer 16b formed entirely of the second mold material 12b.

Referring to FIG. 20D, a detailed view of the parison 14d is provided to illustrate the transition between the first portion 14e and the third portion 14f. As shown, the first portion 14e of the parison 14d includes the first layer 16a of the first mold material 12a having a first thickness T₁₆ₐ₁, which forms the entire thickness of the parison 14d in the first portion 14e. At the second portion 14f, the first layer 16a has a gradually tapering (i.e., decreasing) thickness T₁₆ₐ₂ along the direction from the first portion 14e to the third portion 14g while the second layer 16b has a gradually flaring (i.e., increasing) thickness T_{16b1} along the direction from the first portion 14e to the third portion 14g. The corresponding changes in thicknesses T₁₆ₐ₂, T_{16b1} cooperate to form a gradated visual appearance along the length of the parison 14d. For example, where the first mold material 12a and the second mold material 12b are different colors, the parison 14d gradually transitions from the color of the first mold material 12a to the color of the second mold material 12b through the second portion 14f. At the third portion 14f, the parison 14d includes the second layer 16b of the second mold material 12b having a second thickness T_{16b2} that forms the entire thickness of the parison 14d in the third portion 14g.

In some configurations, one or more of the extruders 102a, 102b may include an accumulator head. An accumulator head is a reservoir that stores a quantity of molten material 12a, 12b from the extruder 102a, 102b and can then expel this material 12a, 12b to the mold 200 at a greater rate than the extruders 102a, 102b. The use of an accumulator head can facilitate the creation of the gradated second portion 14f. For instance, the controller 500 could direct the accumulator head on the first extruder 102a to begin discharging its stored first mold material 12a at a controlled, decreasing rate, while simultaneously signaling the second extruder 102b (with or without an accumulator) to begin extruding the second mold material 12b at a controlled, increasing rate, thereby forming the blended, gradated transition.

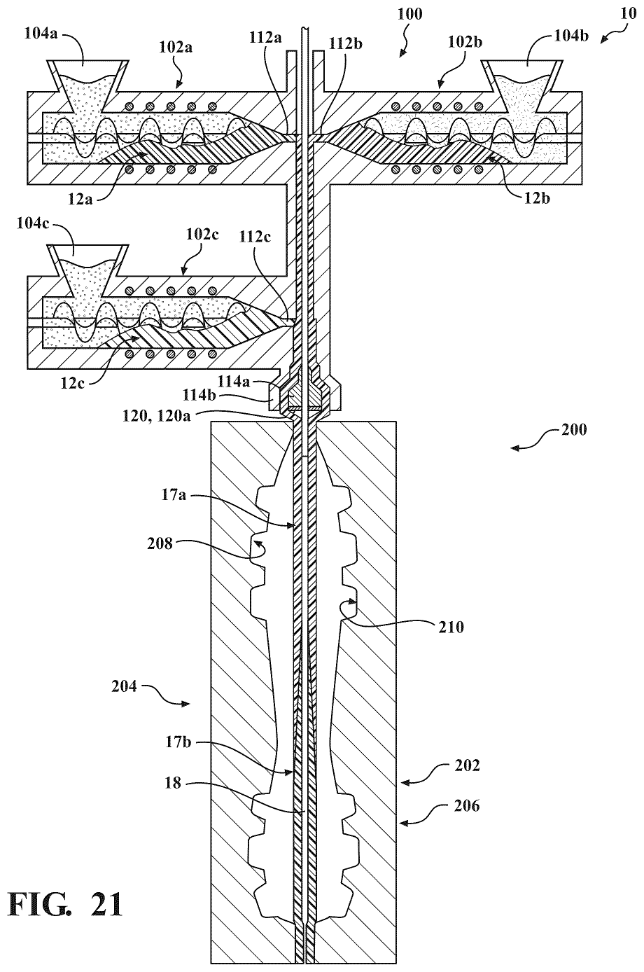

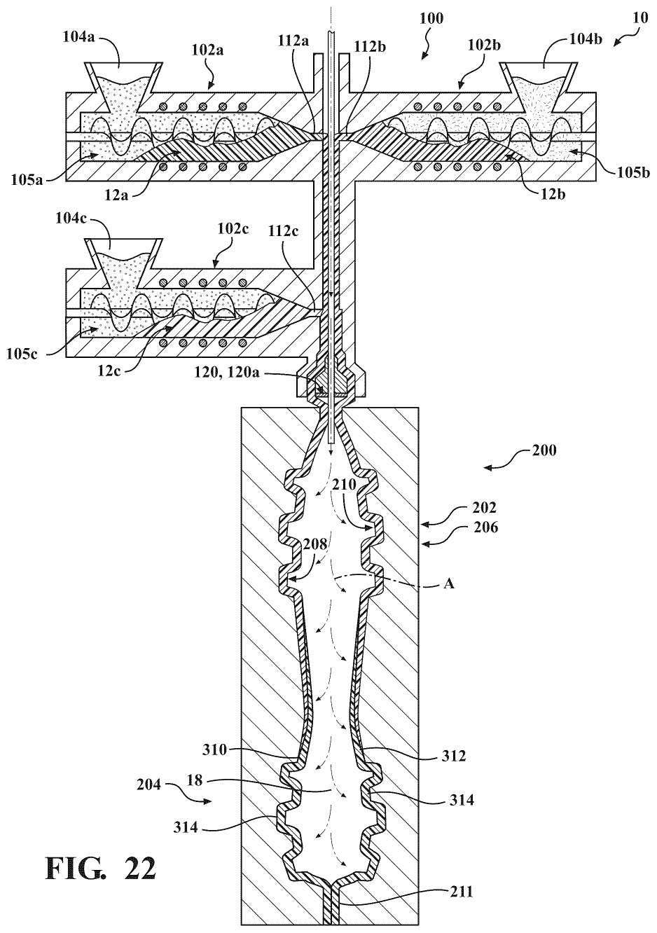

Referring now to FIGS. 21-26, the subsequent molding steps are similar to those described in the previous embodiments. At FIG. 21, the mold assembly 202 is moved to the closed configuration, sealing the gradated parison 14c within the mold chamber 205. At FIG. 22, pressurized fluid is introduced via the blow pin 116, expanding the parison 14c into the mold cavities 208, 210 to form a molded article 300b. The resulting sole plates 306b, 308b will exhibit a material gradient corresponding to the gradated parison 14d, allowing for different physical properties (e.g., stiffness, color, texture) in different areas of the same sole plate.

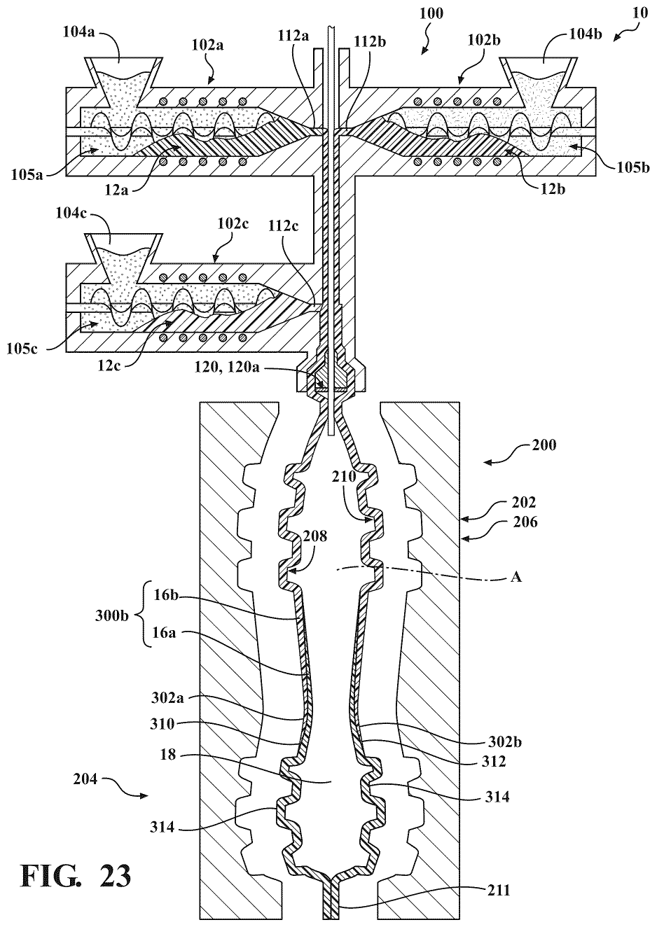

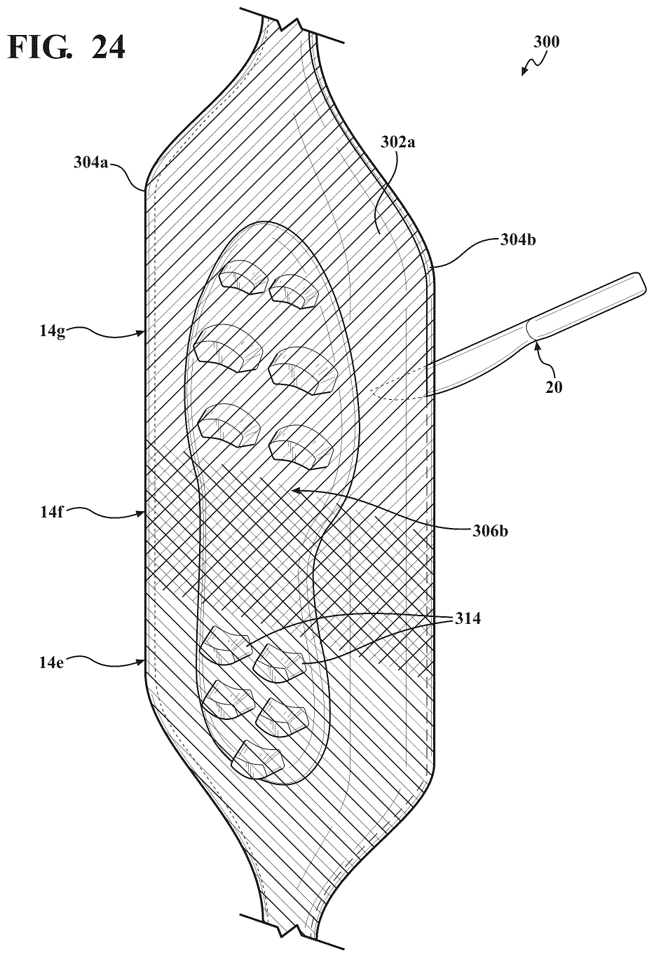

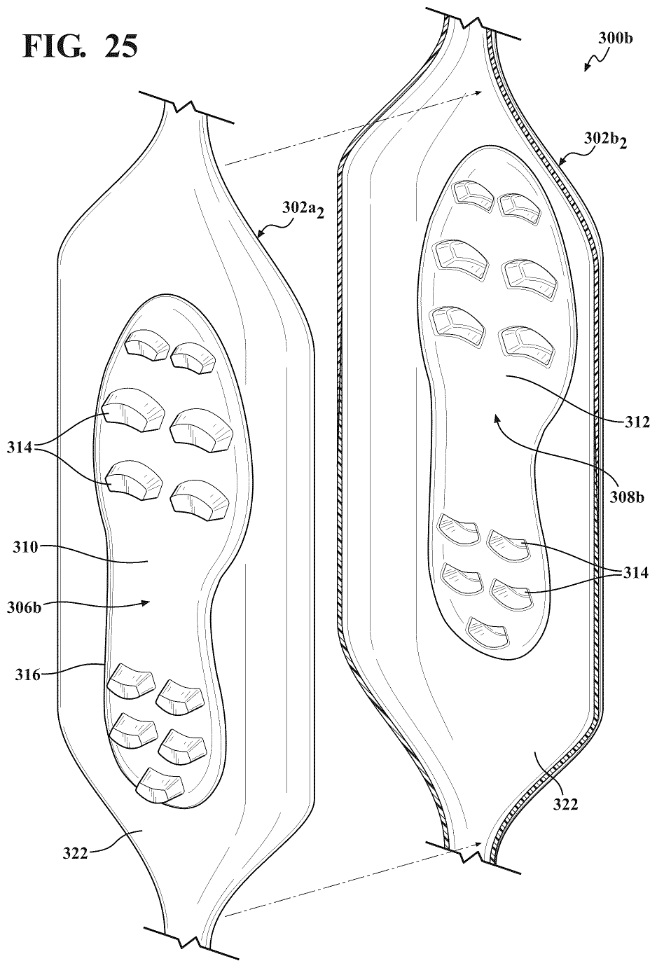

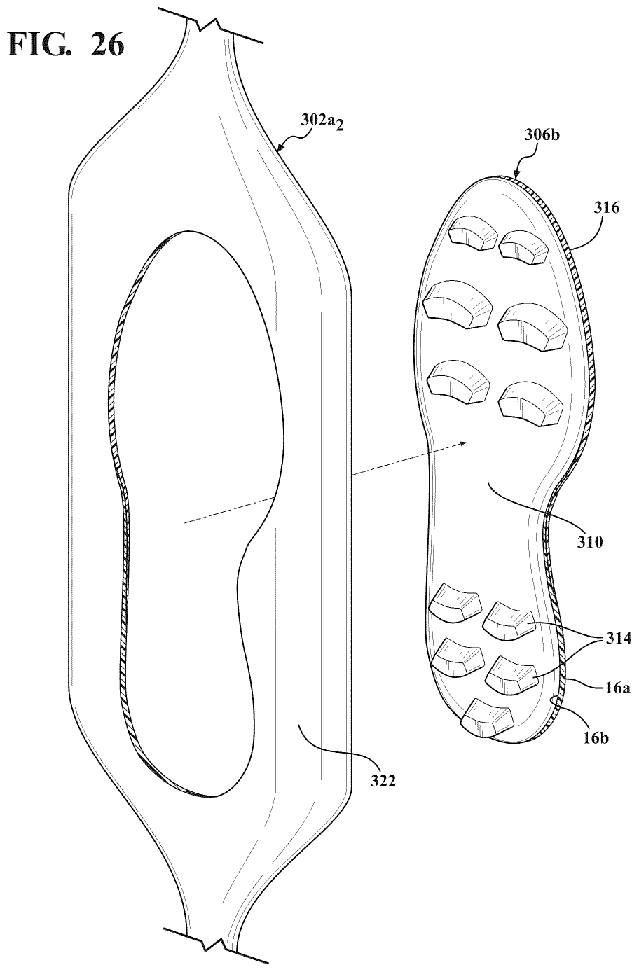

At FIG. 23, the mold assembly 202 is opened for removal of the molded article 300b. As shown in FIGS. 24 and 25, the molded article 300b includes molded article sections 302a2, 302b2, which may be separated from each other. Finally, as shown in FIG. 26, a final sole plate 306b can be removed from the molded article section 302a2 by trimming away the flashing, revealing a component with a functional or aesthetic material gradient.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A blow molding system comprising:
a first extruder extruding a first material;
an end die receiving the first material from the first extruder and including an inner portion, an outer portion, and a passage disposed between the inner portion and the outer portion through which the first material flows before exiting the end die as a parison, the inner portion movable relative to the outer portion to adjust a width of the passage; and
a mold assembly defining a mold chamber having an opening at one end that receives the parison, the mold assembly including a plurality of mold cavities each facing the mold chamber and defining a profile of at least one sole component of an article of footwear.

2. The blow molding system of claim 1, further comprising a second extruder extruding a second material, the second material cooperating with the first material to form the parison.

3. The blow molding system of claim 2, wherein the first extruder extrudes a first layer of the parison and the second extruder extrudes a second layer of the parison, the first layer being concentric with the second layer.

4. The blow molding system of claim 2, further comprising a third extruder extruding a third material defining a third layer of the parison.

5. The blow molding system of claim 4, wherein the first extruder and the second extruder are disposed upstream of the third extruder.

6. The blow molding system of claim 1, wherein the inner portion is translatable relative to and within the outer portion between an extended state and a retracted state, the parison having a first wall thickness when the inner portion is in the extended state that is greater than a second wall thickness when the inner portion is in the retracted state.

7. The blow molding system of claim 1, wherein the inner portion includes an adjustment element disposed at a distal end of the inner portion and opposing the mold assembly, the adjustment element cooperating with an inner surface of the outer portion to define a shape of the parison, as the parison exits the end die.

8. The blow molding system of claim 7, wherein the adjustment element is circular.

9. The blow molding system of claim 7, wherein the adjustment element is oblong.

10. The blow molding system of claim 1, further comprising a controller operably coupled with the inner portion to selectively adjust a position of the inner portion relative to the outer portion.

11. A blow molding system comprising:
a first extruder extruding a first material;
an end die receiving the first material from the first extruder and including an inner portion, an outer portion, and a passage disposed between the inner portion and the outer portion through which the first material flows before exiting the end die as a parison;
a controller operably coupled with the inner portion to selectively move the inner portion relative to the outer portion between an extended state and a retracted state to adjust a width of the passage; and
a mold assembly defining a mold chamber having an opening at one end that receives the parison, the mold assembly including a plurality of mold cavities each facing the mold chamber and defining a profile of at least one sole component of an article of footwear.

12. The blow molding system of claim 11, further comprising a second extruder extruding a second material, the second material cooperating with the first material to form the parison.

13. The blow molding system of claim 12, wherein the first extruder extrudes a first layer of the parison and the second extruder extrudes a second layer of the parison, the first layer being concentric with the second layer.

14. The blow molding system of claim 12, further comprising a third extruder extruding a third material defining a third layer of the parison.

15. The blow molding system of claim 14, wherein the first extruder and the second extruder are disposed upstream of the third extruder.

16. The blow molding system of claim 11, wherein the inner portion is translatable relative to and within the outer portion between the extended state and the retracted state, the parison having a first wall thickness when the inner portion is in the extended state that is greater than a second wall thickness when the inner portion is in the retracted state.

17. The blow molding system of claim 11, wherein the inner portion includes an adjustment element disposed at a distal end of the inner portion and opposing the mold assembly, the adjustment element cooperating with an inner surface of the outer portion to define a shape of the parison, as the parison exits the end die.

18. The blow molding system of claim 17, wherein the adjustment element is circular.

19. The blow molding system of claim 17, wherein the adjustment element is oblong.

20. The blow molding system of claim 11, wherein the inner portion is movable relative to the outer portion to a plurality of positions between the extended state and the retracted state.
